(19) United States
(12) Patent Application Publication
(10) Pub. No.: US 2017/0270522 A1
(43) Pub. Date: Sep. 21, 2017

(54) ONLINE TRANSACTION SYSTEM AND METHODS

(71) Applicant: Crispen Chikuvadze, Dubai (AE)

(72) Inventor: Crispen Chikuvadze, Dubai (AE)

(21) Appl. No.: 15/184,772

(22) Filed: Jun. 16, 2016

(30) Foreign Application Priority Data
Mar. 21, 2016 (IN) 201611009776

(51) Int. Cl. G06Q 20/40; G06Q 10/10; G06Q 50/22; G06Q 10/02; G06Q 50/18

(52) U.S. Cl. CPC G06Q 20/405; G06Q 10/02; G06Q 50/186; G06Q 50/22; G06Q 10/1053

(57) ABSTRACT

A networked system used to implement online transactions and communication between users. The users are account holders at banks located in a plurality of countries. The banks are connected to a computing system that instructs the banks to freeze funds during a quote and book process. After delivery of products and services, the payments the funds are released, thus payment is guaranteed. The networked system retains all records from quote process to payment for every transaction. Individuals have a single account. Company accounts are divided into different sub-users according to the employee's responsibilities and these users can only expend what has been allocated by the Finance sub-user of that company. The Government account is divided into different Ministries connected to the Main Treasury account and Ministries can only expend allocated from the Main Treasury account. Individuals and companies can request services from the Government Ministries on the same networked system.

### CROSS REFERENCE TO RELATED APPLICATION(S)

This application claims priority to Indian Patent Application No. 201611009776, filed on Mar. 21, 2016, and titled PENVEEL-CONVENIENT AND EFFECTIVE PLATFORM FOR SEARCHING, SELECTING AND PAYING TRANSACTIONS, which is incorporated herein by reference in its entirety.

### BACKGROUND OF THE INVENTION

Field of the Invention

The present invention is directed generally to computing systems for conducting electronic transactions.

Description of the Related Art

Many users, including companies, conduct transactions online. Unfortunately, these transactions may be complicated particularly when users are physically located in different countries. Therefore, a need exists for new systems and methods for conducting online transactions. Systems and methods configured to enable transactions between users in different countries would be particularly desirable. The present application provides these and other advantages as will be apparent from the following detailed description and accompanying figures.

### BRIEF DESCRIPTION OF THE SEVERAL VIEWS OF THE DRAWING(S)

FIG. 1 is an illustration of a networked system used to implement online transactions and communication between users.

FIG. 2 is an illustration of multiple countries and examples of banks located in those countries.

FIG. 3 is a flow diagram of a method of setting up a computing system of the networked system of FIG. 1 to conduct transactions between the users.

FIG. 4 is a block diagram of accounts on the computing system and their relationship to bank accounts.

FIG. 5 is a block diagram showing a plurality users with access to a company account.

FIG. 6 is a flow diagram of a method of implementing a bidding or quotation process.

FIG. 7 is a flow diagram of a method of implementing an invoicing and release of funds process.

FIG. 8 is a flow diagram of a method of implementing a purchasing process.

FIG. 9 is a flow diagram of a method of implementing a payment.

FIG. 10 is a flow diagram of a method of determining whether a parking fee has been paid for a particular vehicle for a parking location and ticketing the vehicle if the fee was not paid.

FIG. 11 is a flow diagram of a method performed by human resources users.

FIG. 12 is a flow diagram of a method of processing requests submitted by employees.

FIG. 13 is a block diagram showing a main government account and sub-organization accounts.

FIG. 14 is a diagram of a hardware environment and an operating environment in which the computing devices of the system of FIG. 1 may be implemented.

Like reference numerals have been used in the figures to identify like components.

### DETAILED DESCRIPTION OF THE INVENTION

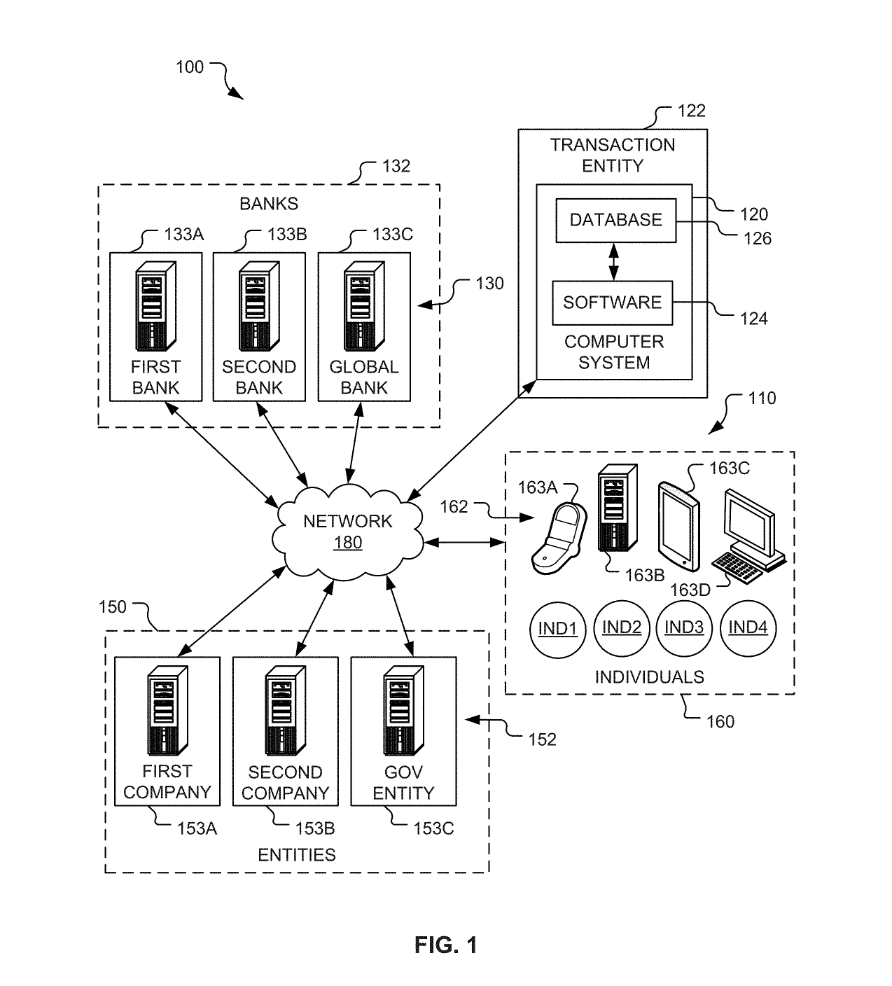

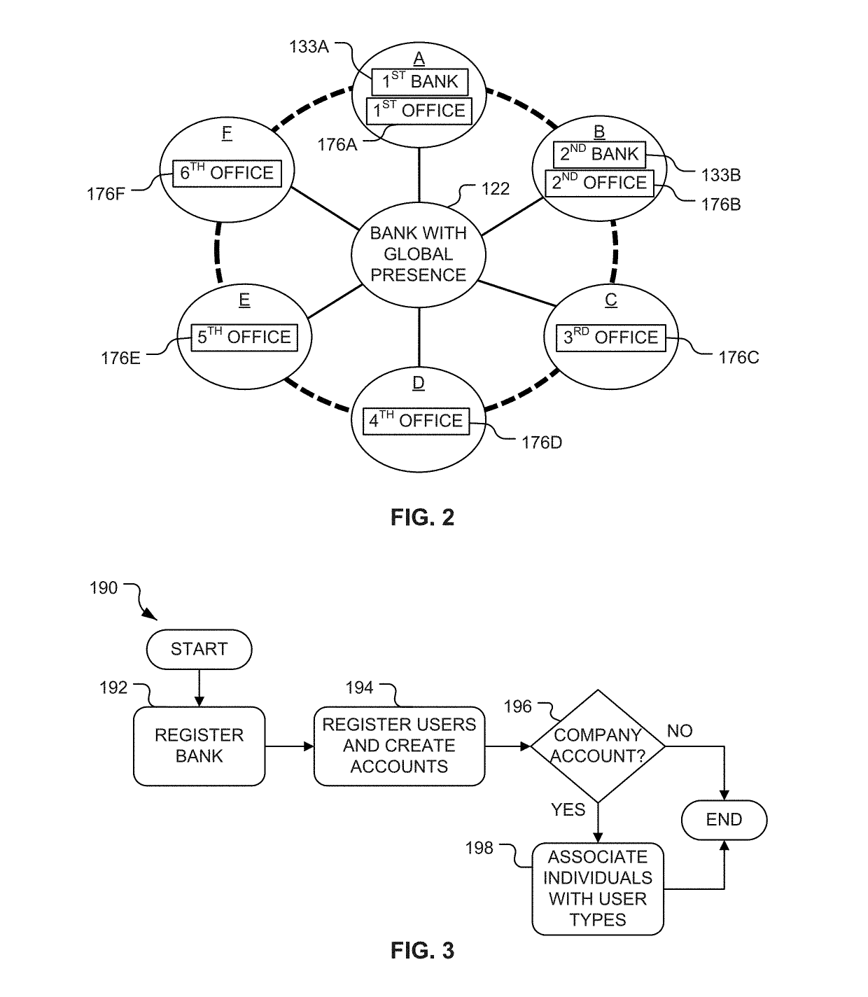

FIG. 1 depicts a networked system 100 used to implement online transactions (e.g., searching, processing, and paying) and communication between users 110. The system 100 includes a computing system 120 operated by a transaction entity 122. The computing system 120 implements transaction software 124 and, optionally, a database 126. The transaction software 124 is configured to store data in and retrieve data from the database 126, when present. As shown in FIG. 2, the transaction entity 122 may be a bank with a global presence. On the other hand, the transaction entity 122 may provide some of the functionality of a global bank but need not actually be a bank.

Returning to FIG. 1, the system 100 includes a plurality of banking computing systems 130 operated by different banks 132. The banks 132 may be located in different countries A-F (see FIG. 2) around the world. Each of the banks 132 may or may not have a global presence. For ease of illustration, in FIG. 1, the banks 132 include a first bank 133A located in the country A (see FIG. 2), a second bank 133B located in the country B (see FIG. 2), and a global bank 133C (which has a global presence). However, the banks 132 may include any number of banks each like one of the banks 133A-133C.

Some of the banks 132 may have one or more different offices or branches. Referring to FIG. 2, the global bank 133C (see FIG. 1) may have branches/offices 176A-176F located in more than one of the countries A-F. In the example illustrated in FIG. 2, the offices 176A-176F of the global bank 133C (see FIG. 1) are located in the countries A-F, respectively. While FIG. 2 illustrates only six different countries, the system 100 may be used with any number of different countries or jurisdictions.

Returning to FIG. 1, the users 110 include entities 150 and individuals 160. By way of non-limiting examples, the entities 150 may include one or more governmental organizations (e.g., a government entity 153C, which may be implemented as a government, a government department, a government authority, and the like) and/or private organizations (e.g., companies 153A and 153B, non-profit organizations, and the like). For ease of illustration, the entities 150 have been illustrated as including the three entities (namely, the companies 153A and 153B and the government entity 153C) and the individuals 160 have been illustrated as including four individuals IND1-IND4. However, the system 100 may be used by any number of entities and/or individuals.

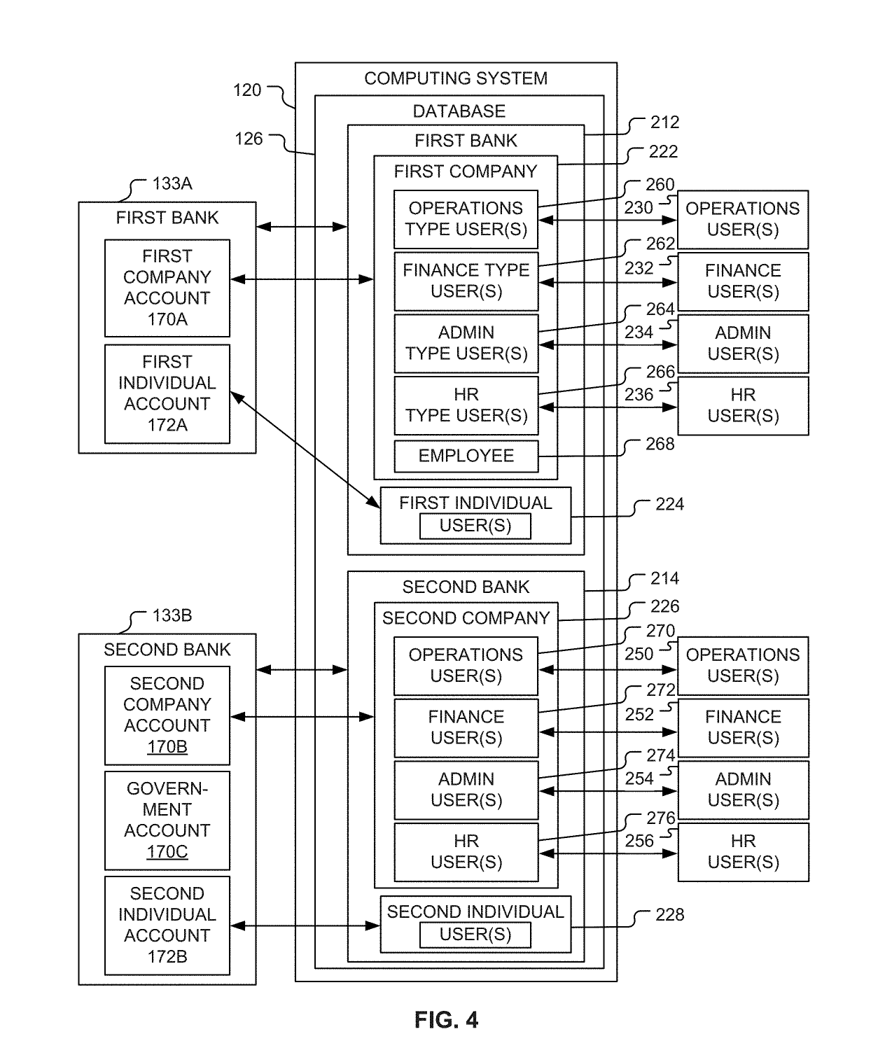

The users 110 are account holders or customers of the banks 132. Referring to FIG. 4, by way of a non-limiting example, the first company 153A has a first company account 170A at the first bank 133A and the individual IND1 has a first individual account 172A at the first bank 133A. Similarly, in the example illustrated, the second company 153B has a second company account 170B at the second bank 133B, the government entity 153C has a government account 170C at the second bank 133B, and the individual IND2 has a second individual account 172B at the second bank 133B.

Returning to FIG. 1, the individuals 160 access the computing system 120 using computing devices 162. For ease of illustration, in FIG. 1, the individuals IND1-IND4 operate computing devices 163A-163D, respectively. The individuals IND1 and IND2 may access their individual accounts 172A and 172B (see FIG. 4), respectively, using the computing devices 163A and 163B, respectively. The first company 153A, the second company 153B, and the government entity 153C may use computing systems 152 to access their accounts 170A-170C (see FIG. 4), respectively.

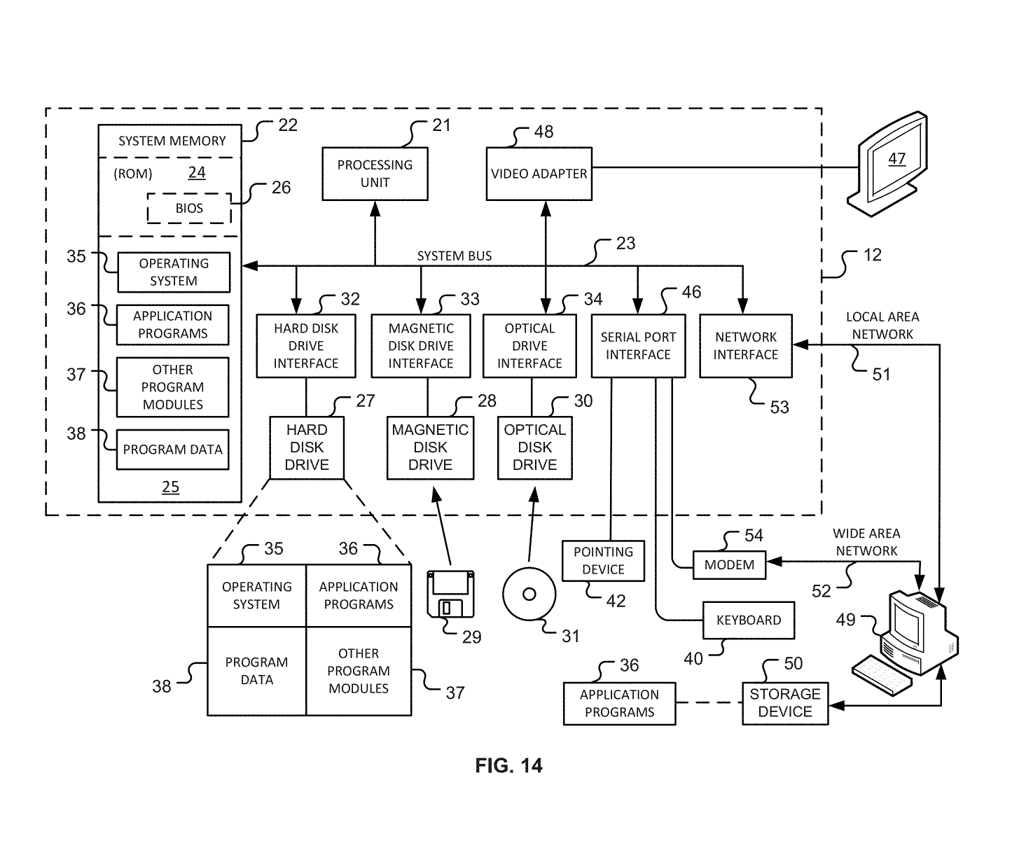

The computing systems 120, 130, and 152 and the computing devices 162 are all interconnected by a network 180 (e.g., the Internet). Each of the computing systems 120, 130, and 152 and the computing devices 162 may each be implemented as a computing device 12 (see FIG. 14) described below.

FIG. 3 is a method 190 of setting up the computing system 120 (see FIGS. 1 and 4) to conduct transactions between the users 110 (see FIG. 1). In first block 192, referring to FIG. 1, the banks 132 use the computing systems 130 to register with the computing system 120 (e.g., upon fulfilling particular terms and conditions). Referring to FIG. 4, for each bank registered, the software 124 (see FIG. 1) may create a record in the database 126. By way of non-limiting example, FIG. 4 shows records 212 and 214 created for the first and second banks 133A and 133B, respectively, when they were registered with the computing system 120.

Returning to FIG. 3, in block 194, the users 110 (the entities 150 and the individuals 160 illustrated in FIG. 1) are registered with the computing system 120 (see FIG. 1). For each user registered, the software 124 (see FIG. 1) creates an individual account and/or a company account (e.g., in the database 126) and assigns a unique user identification (“ID”) to the user. The user ID may be used to make payments (from an account associated with the user ID) to other users within the same country or anywhere in the world.

By way of non-limiting example, FIG. 4 shows a first company account 222 created by the software 124 (see FIG. 1) for the first company 153A (see FIG. 1) and a first individual account 224 created by the software 124 for the individual IND1 (see FIG. 1). As shown, the computing system 120 associates both the first company account 222 and the first individual account 224 with the first bank 133A. The computing system 120 also associates the first company account 170A and the first individual account 172A with the first company account 222 and the first individual account 224, respectively. Using these relationships, the software 124 (see FIG. 1) may instruct the first bank 133A to freeze and/or release a portion of the funds in the first company account 170A and/or the first individual account 172A.

Similarly, FIG. 4 shows a second company account 226 created by the software 124 (see FIG. 1) for the second company 153B (see FIG. 1) and a second individual account 228 created by the software 124 for the individual IND2 (see FIG. 1). As shown, the computing system 120 associates both the second company account 226 and the second individual account 228 with the second bank 133B. The computing system 120 also associates the second company account 170B and the second individual account 172B with the second company account 226 and the second individual account 228, respectively. Using these relationships, the software 124 (see FIG. 1) may instruct the second bank 133B to freeze and/or release a portion of the funds in the second company account 170B and/or the second individual account 172B.

Optionally, in block 194, the banks 133A and 133B may upload and register their users with the computing system 120. Alternatively, the banks 133A and 133B may input lists of their users and those users may register themselves. The individuals 160 (see FIG. 1) may register personal information (such as physical address and phone number(s)) and the entities 150 (see FIG. 1) may register entity information (such as identities of directors and shareholders).

While an individual account (e.g., the first individual account 224) may be accessed by a single type of user (e.g., the individual IND1 illustrated in FIG. 1), a company account (e.g., the first company account 222) may be accessed multiple types of users (or employees) with different roles or functionality with respect to the company. In decision block 196, a decision is made whether each new account is a company account. The decision in decision block 196 is “NO,” when the new account is an individual account and the method 190 terminates.

On the other hand, the decision in decision block 196 is “YES,” when the new account (e.g., the first company account 222) is a company account. When the decision is “YES,” in block 198, one or more of the individuals 160 (e.g., employees) are associated with each user type. Each individual associated with a user type has access to the company account. Further, the funds in the company account may be divided or allocated between the different user types.

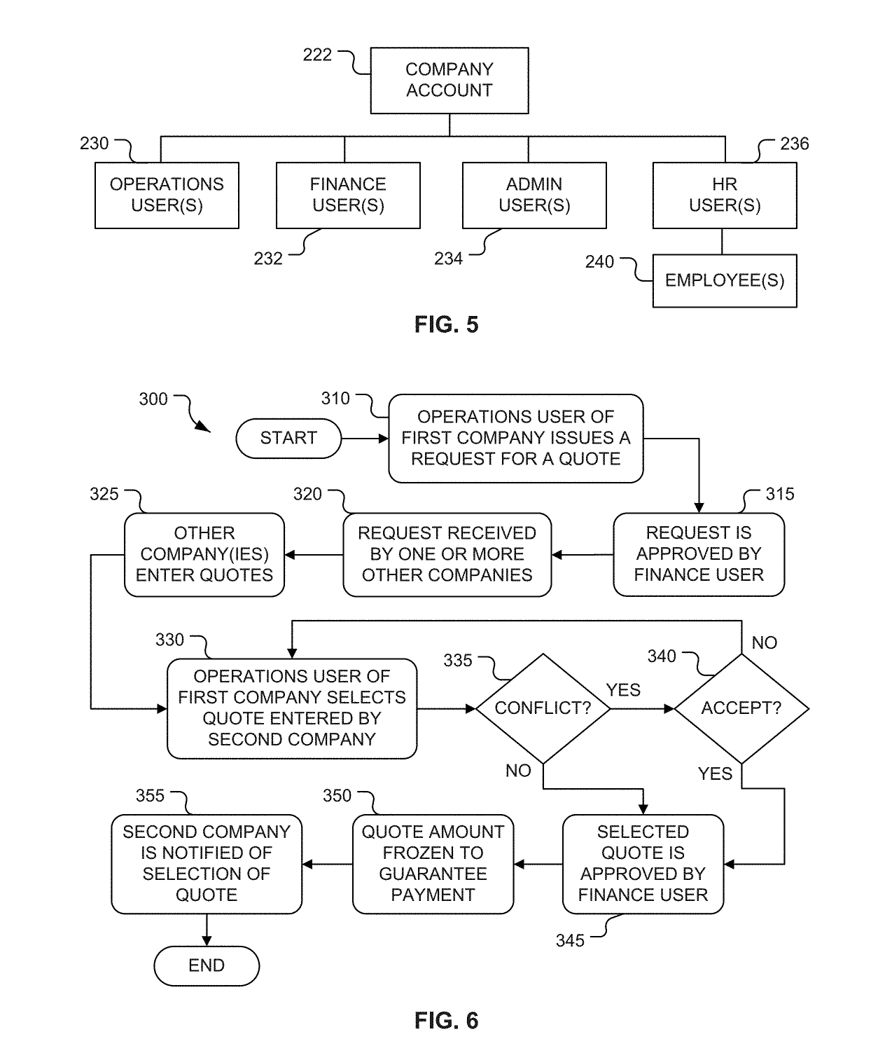

By way of an example, referring to FIG. 5, four different user types may be associated with a particular company account (e.g., the company account 222): operations user type, finance user type, administrative user type, and human resources (“HR”) user type. One or more individuals may be associated with each user type. Thus, as shown in FIG. 5, the company account 222 may be accessed by one or more operations users 230, one or more finance users 232, one or more administrative users 234, and one or more HR users 236. The users 230-236 may work for an operations department, a finance department, an administration department, and a HR department, respectively. However, this is not a requirement. Similarly, referring to FIG. 4, the second company account 226 may be accessed by one or more operations users 250, one or more finance users 252, one or more administrative users 254, and one or more HR users 256.

Referring to FIG. 4, for each individual associated with a user type, the computing system 120 creates a record in the database 126. By way of non-limiting example, FIG. 4 shows records 260-266 created for the users 230-236, respectively, and records 270-276 created for the users 250-256, respectively.

Referring to FIG. 5, the HR user(s) 236 may connect other employees 240 to the company account 222. In other words, the employees 240 may be registered with the computing system 120 by the HR user(s) 236. Thus, the users 230-236 may connect (or communicate) with the employees 240 via the company account 222 and/or individual accounts held by the employees 240 (and registered with the computing system 120).

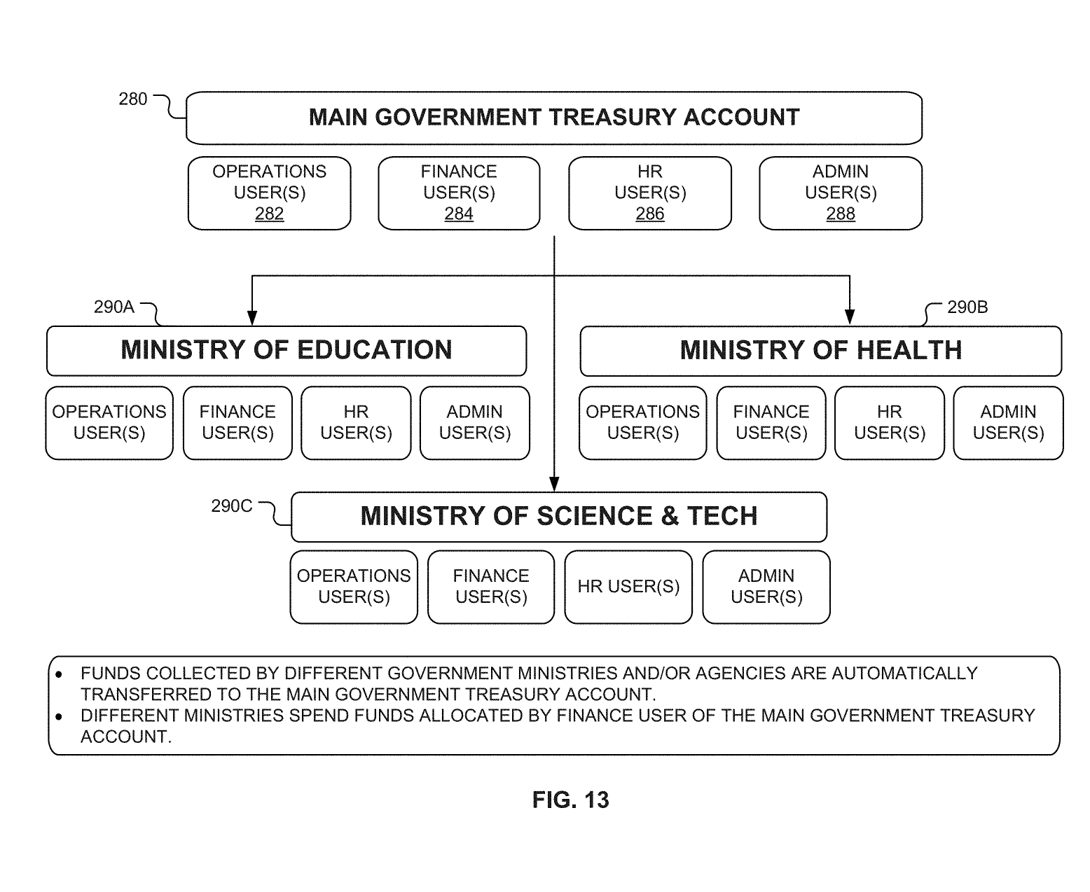

Referring to FIG. 1, as mentioned above, the entities 150 may include governmental organizations (e.g., the government entity 153C). If the government entity 153C is a government or a treasury, the government entity 153C may set up (using the method 190 illustrated in FIG. 3) a main government account 280 (see FIG. 13) for use by multiple user types. For example, referring to FIG. 13, the main government account 280 (labelled “main government treasury account”) may be set up for use by operations, finance, administrative, and HR users 282-288. Similarly, the governments of each of the countries A-F (see FIG. 2) may each have a main government account (like the main government account 280) and relationships (or associations) may be set up for sub-organizations (e.g., ministries, agencies, and the like) within the government. For example, the main government account 280 may create replica accounts 290A-290C (referred to as “sub-organization accounts”) in the computing system 120 for different accounts held by the sub-organizations. Referring to FIG. 4, the sub-organization accounts 290A-290C may operate like the company accounts 222 and 226; however, funds received by the different sub-organizations may be credited to the main government account 280 of the government (e.g., controlled by the treasury). As shown in FIG. 13, the employees of the various ministries and/or agencies within a particular governmental organization may be registered as operations, finance, administrative, and HR users. The main government account 280 may allocate funds to the sub-organizations (e.g., to the sub-organization accounts 290A-290C) for their expenditures (which may be allocated by one or more of the finance user(s) 284). Thus, the sub-organizations can only spend the funds allocated by the government.

Referring to FIG. 1, after the entities 150 have each registered, they can connect with other users (e.g., their other branches, outlets, and partners both locally and in other countries). The entities 150 may specify relationships (in the computing system 120) between themselves and other users 110. For example, one of the entities 150 may specify whether another user 110 (e.g., a particular branch) is a subsidiary, a parent company, a branch, a partner, joint venture, and the like. The entities 150 may assign rights to related users 110 (e.g., branches, outlets, partners, and the like) anywhere in the world. By way of non-limiting examples, the rights assigned may include one or more of the following;

1. rights to approve quotes and payments;

2. viewing rights only;

3. no rights (just connection); and

4. viewing rights to certain selected information;

By way of non-limiting examples, connected or related users may include hospitals and medical insurance companies, different airlines sharing a loyalty program, and the like. By way of another non-limiting example, related entities (e.g., different branches of the same company) may send communications to one another. For example, a first branch may send an inquiry to a second branch as to whether the second branch would like to take advantage of a supplier discount by combining a first purchase of the first branch with a second purchase of the second branch.

The users 110 (e.g., the individual IND3) may delegate responsibilities to one or more other user(s) (e.g., the individual IND4). For example, the individual IND3 may delegate responsibilities to the individual IND4 before the individual IND3 goes on leave. The individual IND3 may input a start date and an end date of the leave, select the individual IND4 (by the user ID assigned to the individual IND4), and enter a selection indicating that the individual IND3 is delegating responsibilities to the individual IND4. The individual IND4 receives a password that will be valid for the duration of the leave. During this time, the individual IND4 may perform all the functions assigned to the individual IND3. For example, if the individual IND3 is one of the operations user(s) 230 (see FIG. 4) and the individual IND4 is one of the finance user(s) 232 (see FIG. 4), the individual IND4 may perform the duties of the operations user(s) 230 as well as the duties of the finance user(s) 232. The individual IND3 may choose to receive notifications from the computing system 120 during the leave.

The computing system 120 may be characterized as grouping bank accounts (e.g., held in different countries) and allowing the users 110 of these bank accounts to transfer funds or make payments to other users of the computing system 120. The computing system 120 also allows the users 110 to communicate with another. For example, an insurance company user of the computing system 120 may obtain a confirmation or other information (e.g., a police report) from another user (e.g., a police department) of the computing system 120 before making a payment to an insured user of the computing system 120.

Further, users may connect their accounts to one or more other accounts and share information therebetween. A first user of a connected account may view information regarding the other connected account(s) (as permitted by the user(s) of the account(s)) and may, for example, approve quotes, approve payments, and generate (and view) reports using the computing system 120.

Additionally, users may assign rights (e.g., right to approve payments) to other users and/or confirm actions taken by other users. For example, a first user may select a second user (e.g., a lawyer) to confirm fulfilment of a condition. After this condition is satisfied (e.g., a transfer of property has occurred), funds may be released (or transferred to another user).

Day to-day business activities of a user (e.g., the first company 153A) may be connected to the user's account (e.g., the first company account 222) implemented by the computing system 120 and the computing system 120 may record such business activities. For example, tickets booked by an airline company may be connected with its bank account (via a company account on the computing system 120). At the same time, one of these tickets booked by an individual may be connected with the individual's bank account (via an individual account on the computing system 120). This information may be used to provide information (e.g., a flight schedule) to the individual and/or others.

After the users 110 (who may be located around the world) have been registered, they may perform one or more of the methods 300-900 illustrated in FIGS. 6-12, respectively.

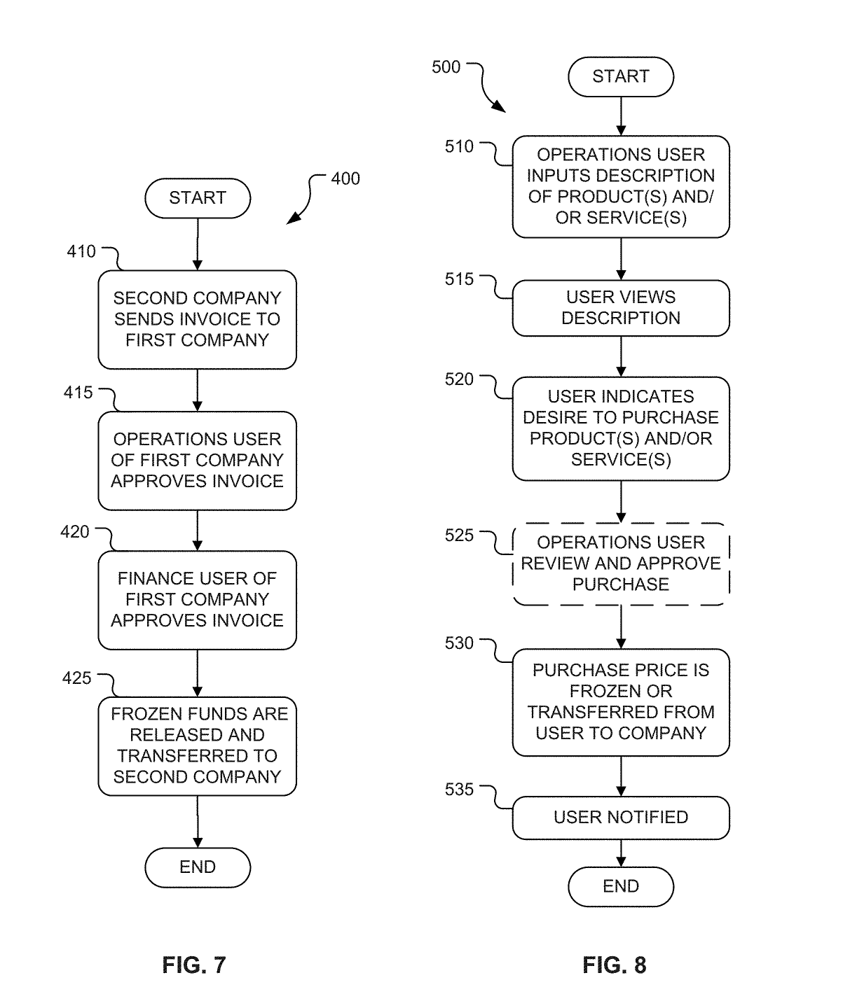

The method 300 (see FIG. 6) implements a bidding or quotation process and the method 400 (see FIG. 7) implements an invoicing and release of funds process. For ease of illustration, the methods 300 and 400 will be described as being performed by the first and second companies 153A and 153B (see FIG. 1). Before the methods 300 and 400 are performed, the operations user(s) 250 may enter or upload a description of the types of products and/or services offered by the second company 153B (see FIG. 1).

Referring to FIG. 6, in first block 310, one or more of the operations users 230 (see FIG. 4) of the first company 153A (see FIG. 1) issues a request for a bid or quote. This request is entered into the computing system 120 (e.g., via one of the computing systems 152 illustrated in FIG. 1). The request includes a description of one or more products and/or services the first company 153A wishes to purchase.

In next block 315, the request is approved by one or more of the finance users 232 (see FIG. 4) of the first company 153A (see FIG. 1). After the request is approved, the computing system 120 (see FIGS. 1 and 4) notifies other relevant companies (e.g., the second company 153B illustrated in FIG. 1) of the request. The computing system 120 may determine which companies to notify of the request based on the descriptions of the types of products and/or services entered by the second company 153B.

In next block 320, the relevant companies (e.g., the second company 153B illustrated in FIG. 1) review the request. The request is associated with the user ID of the first company 153A. Optionally, in the request, the first company 153A may be identified by only its user ID. In block 320, the computing system 120 displays the request to the relevant companies (via the computing systems 152 illustrated in FIG. 1). The computing system 120 also displays an input (e.g., a quotation box) into which the companies may enter a quote. The input may be viewable for at least two working days excluding weekends. The input may be viewable by those users registered (or associated) with the relevant companies. By way of a non-limiting example, the input may be viewable by the users 250-256 (see FIG. 4) registered with the second company 153B and the users registered with other companies. Optionally, both the request and the input are viewable by all users.

In block 325, those of the relevant companies wishing to respond to the request enter a quote (that includes a monetary price amount) into the input. By way of a non-limiting example, the operations users 250 (see FIG. 4) of the second company 153B (see FIG. 1) may enter a quote. The quote is associated with the user ID of the second company 153B. Optionally, in the quote, the second company 153B may be identified by only its user ID.

In block 330, the operations users 230 (see FIG. 4) of the first company 153A (see FIG. 1) review any quotes received in response to the request and select a quote from one of the relevant companies (e.g., the quote entered by the second company 153B).

If there are any potential conflicts of interest, the decision in decision block 335 is “YES.” Otherwise, the decision in decision block 335 is “NO.” By way of a non-limiting example, a conflict occurs when the selected company has one or more directors in common with the first company 153A.

When the decision in decision block 335 is “YES,” in decision block 340, the operations users 230 (see FIG. 4) of the first company 153A (see FIG. 1) determine whether the conflict is acceptable. The decision in decision block 340 is “YES” when the conflict is acceptable. Otherwise, the decision in decision block 340 is “NO.” If the decision in decision block 340 is “NO,” the operations users 230 of the first company 153A select a different quote in block 330.

If the decision in decision block 335 is “NO” or the decision in decision block 340 is “YES,” in block 345, the selected quote is approved by one or more of the finance users 232 of the first company 153A.

In block 350, the computing system 120 instructs the first bank 133A to freeze (or hold) the price amount of the quote in the first company account 222 (see FIG. 4) to guarantee payment by the first company 153A (see FIG. 1).

In block 355, the company (e.g., the second company 153B) that supplied the quote that was selected in block 330 (the “selected company”) is notified of the selection. Then, the method 300 terminates.

After the method 300 terminates, the selected company supplies the one or more products and/or services described in the request.

As mentioned above, the method 400 implements the invoicing and release of funds process. Referring to FIG. 7, in first block 410, the selected company (e.g., the second company 153B illustrated in FIG. 1) enters an invoice into the computing system 120 (see FIGS. 1 and 4) after supplying the one or more products and/or services described in the request. The computing system 120 sends the invoice to the first company 153A (see FIG. 1). Optionally, in the invoice, the first company 153A may be identified by only its user ID.

In next block 415, the invoice is reviewed and approved by one or more of the operations users 230 (see FIG. 4) of the first company 153A using the computing system 120.

In next block 420, the invoice is reviewed and approved by one or more of the finance users 232 (see FIG. 4) of the first company 153A (see FIG. 1) using the computing system 120.

In block 425, the computing system 120 instructs the first bank 133A (see FIGS. 1 and 4) to release the frozen (or held) funds (totaling the price amount of the quote) from the first company account 222 (see FIG. 4) and transfer these funds to the second company account 226 (see FIG. 4).

Then, the method 400 terminates.

Thus, together, the methods 300 and 400 (see FIGS. 6 and 7, respectively) implement a bidding and payment process in which the computing system 120 requests that the relevant bank freeze the payment (in the quote amount) before the product(s) and/or service(s) are delivered. Then, after the product(s) and/or service(s) are delivered, the invoice is processed and approved. Finally, the frozen funds are released and paid to the appropriate user.

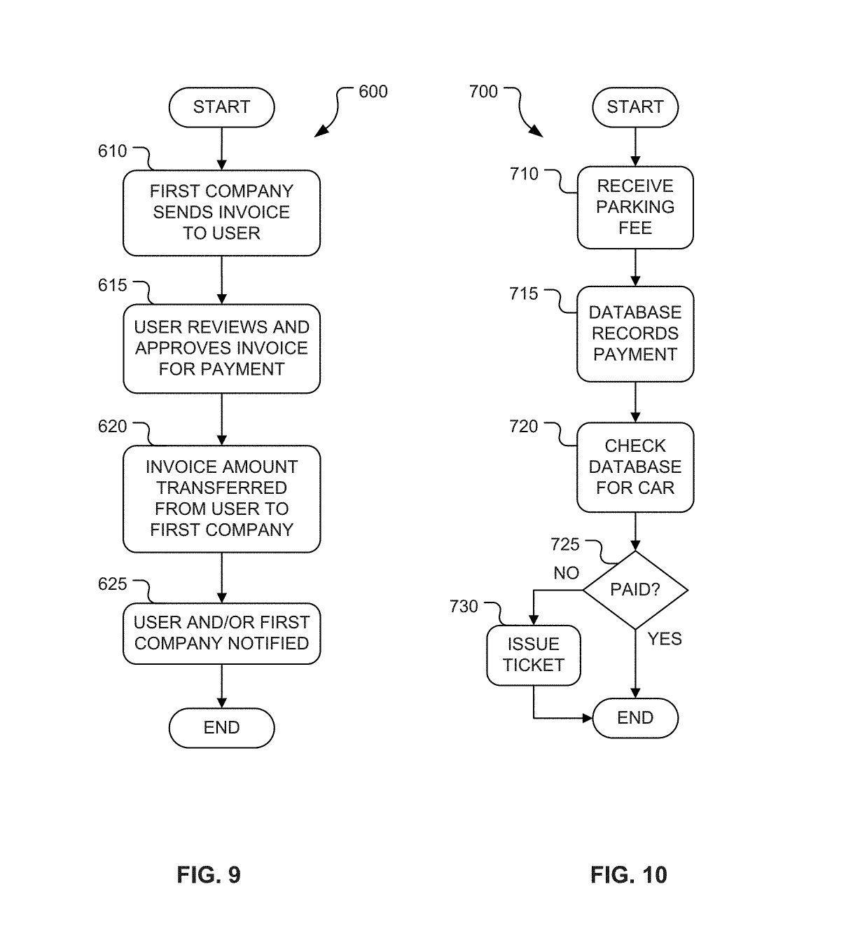

The method 500 (see FIG. 8) implements a purchasing process and the method 600 (see FIG. 9) implements a payment process using the computing system 120. For ease of illustration, the methods 500 and 600 will be described as being performed by the first company 153A and the individual IND2 (see FIG. 1).

Referring to FIG. 8, in first block 510, the operation user(s) 230 (see FIG. 4) enter descriptions of products and/or services and associated prices of each into the computing system 120.

In block 515, the individual IND2 views the descriptions, which are displayed by the computing system 120.

In block 520, the individual IND2 indicates a desire to purchase one or more of the products to and/or services the computing system 120 and the computing system 120 sends a notification to the first company 153A. Optionally, in the notification, the individual IND2 may be identified by only the user ID assigned to the individual IND2.

In optional block 525, the operation user(s) 230 may review and approve the purchase.

Then, in block 530, the computing system 120 instructs the second bank 1336 (see FIGS. 1 and 4) to either freeze (or hold) the purchase price in the second individual account 228 (see FIG. 4) to guarantee payment to the first company 153A or transfer the purchase price from the second individual account 228 (see FIG. 4) to the first company account 222 (see FIG. 4).

In block 535, the individual IND2 may be notified of the status of the purchase and/or payment. Then, the method 500 terminates. After the method 500 terminates, the first company 153A delivers the product(s) and/or performs the service(s).

As mentioned above, the method 600 (see FIG. 9) implements a payment process. Referring to FIG. 610, the first company 153A sends an invoice via the computing system 120 to the individual IND2. Optionally, in the invoice, the individual IND2 may be identified by only the user ID assigned to the individual IND2 and/or the first company 153A may be identified by only its user ID.

In next block 615, the individual IND2 reviews the invoice (displayed by the computing system 120) and approves payment of the invoice.

In block 620, the computing system 120 instructs the second bank 1336 to transfer the invoice amount from the second individual account 228 (see FIG. 4) to the first company account 222 (see FIG. 4). If the method 600 is being performed after the method 500 and, in block 530, the bank 133B froze (or held) funds, in block 620, the computing system 120 instructs the second bank 1336 to release the frozen (or held) funds (totaling the invoice amount) and transfer the invoice amount from the second individual account 228 (see FIG. 4) to the first company account 222 (see FIG. 4).

Then, in block 625, the individual IND2 and/or the first company 153A are notified of the transfer. Then, the method 600 terminates.

Thus, using the methods 300-600 illustrated in FIGS. 6-9, respectively, the users 110 (see FIG. 1) can make payments, receive funds, and/or seek quotations from other registered users anywhere in the world. Optionally, all of these functions may be performed using only the user IDs of the relevant users. Delivery of quoted price amounts are guaranteed because the computing system 120 automatically instructs the banks 132 to freeze the funds and release them after the product(s) and/or service(s) has been provided. The net payables between the different banks 132 and/or countries may be settled internally by the banks 132. Optionally, funds transfer and payments (including international transfers) may be implemented using only the recipient's user ID. Thus, the transfer of funds is easier than prior art methods that require swift codes, account numbers, and/or International Bank Account Numbers (“IBANs”). Optionally, a first user may purchase a product or service using the user ID of another second user provided the second user approves the purchase (e.g., using one of the computing devices 162).

Whenever one of the users 110 makes a purchase using the computing system 120, the computing system 120 records one or more of the following pieces of information and associates this information with the relevant account(s) on the computing system 120:
1. Search criteria used to identify relevant requests for quotes;
2. Search results;
3. Details included in requests for quotes;
4. Users from which quotes were requested;
5. Users excluded from quote process;
6. Quotes received;
7. Details related to selected quotes (including the user(s) who selected the quotes and the user(s) who approved the selection);
8. Invoices received; and
9. The user(s) who approved the invoices.
   Information recorded by the computing system 120 may be recalled and viewed by the user(s) associated with the information.

### Operations User(s)

Referring to FIG. 4, the operations user(s) 230 and 250 are generally responsible for the core business activities of the first and second companies 153A and 1536 (see FIG. 1), respectively. Thus, the function(s) of the operations user(s) 230 and 250 depend upon the core business of the first and second companies 153A and 1536, respectively. For the sake of brevity, the functions performed by the operations user(s) 250 are described below. However, the operations user(s) 230 perform substantially similar functions with respect to the first company 153A.

Referring to FIG. 1, the operations user(s) 250 (see FIG. 4) input or upload, into the computing system 120, a description of products and/or services provided by the second company 1536 and their associated prices for any products and/or services offered by the second company 1536 to other users 110 of the system 100. The computing system 120 displays such products and/or services to the other users 110 (the entities 150 and/or the individuals 160) of the system 100. The operations user(s) 250 receive requests for these products and/or services and invoice the purchaser (e.g., the first company 153A) after the products and/or services have been provided.

The operations user(s) 250 may manage a customer table or database (e.g., listing students for academic institutions, passengers for airlines, customers for many types of businesses, and the like) within the database 126 (see FIG. 1).

The operations user(s) 250 may receive requests for quotes and enter quote amounts in response to such requests. The operations user(s) 250 may include a procurement team responsible for purchases made by the second company 153B. Thus, the operations user(s) 250 may request or search for quotes from other users.

The operations user(s) 250 may select other users who must confirm the fulfilment of an event (e.g., a transfer of ownership before payment is released). For example, when a property (e.g., a house) is purchased, the transacting parties may select one or more lawyers who release payment using the computing system 120 after ownership is transferred. A user may also select a background verification company to confirm that the asset is owned by the individual selling it. Thus, using the computing system 120, the background verification company may first confirm ownership and the lawyer(s) may confirm the transfer of the ownership before payment is released. After this occurs, the purchaser (or others) may request registration (or recording) of the purchase with relevant governmental authorities using the computing system 120.

The operations user(s) 250 may offer delivery service options. Thus, users may shop, make instant payments, and request delivery of the purchased items (e.g., property, food, etc.) using the computing system 120.

The operations user(s) 250 may include security personnel. Such operations user(s) may view recently purchased items (e.g., recorded in the database 126 by the computing system 120) when checking purchases (e.g., at exit points). Thus, there is no need to print receipts because the users have electronic receipts displayable on the computing devices 162 (e.g., mobile phones). The security personnel may view these electronic receipts on the computing devices 162 or on their company mobile devices (e.g., tablets).

### Finance User(s)

Referring to FIG. 4, the finance user(s) 232 and 252 generally allocate funds to other company departments and users (e.g., operations, HR, and administrative users), approve quotes selected by these users, and approve payments before the funds are released by the banks 133A and 133B, respectively. For the sake of brevity, the functions performed by the finance user(s) 252 are described below. However, the finance user(s) 232 perform substantially similar functions with respect to the first company 153A.

The finance user(s) 252 may deposit funds directly into the second bank 133B and/or request (short or long-term) loans from the second bank 133B. Before investing funds with the second bank 133B, the finance user(s) 252 may determine whether other branches of the second company 153B require any funds.

The finance user(s) 252 may also perform an auditor review function. By way of non-limiting example, the finance user(s) 252 may access an auditor function (e.g., using a tab labeled “Auditors tab”). From this tab, the finance user(s) 252 may assign viewing rights to one or more auditors. These rights allow the auditor(s) to view information associated with the second company account 226 and/or the company account 170B. The finance user(s) 252 may add an email address for each auditor to which the computing system 120 may send login information (e.g., a password). The auditor(s) may use the login information to log into the computing system 120, view information, and generate reports with respect to the company account 226 and/or the company account 170B.

The finance user(s) 252 may also input an email address for a manager of the auditor(s). The manager may receive a log of activities (e.g., when the auditor(s) were logged on, what the auditor(s) viewed, reports generated by the auditor(s), etc.) performed by the auditor(s) for a period of time (e.g., every month). For government departments, the manager may be the Auditors General and the like.

### Administrative User(s)

The administrative user(s) 234 and 254 are responsible for administrative activities (e.g., airline bookings requests) of the first and second companies 153A and 153B, respectively. For the sake of brevity, the functions performed by the administrative user(s) 254 are described below. However, the administrative user(s) 234 perform substantially similar functions with respect to the first company 153A.

By way of a non-limiting example, the administrative user(s) 254 may receive requests from employees (e.g., one of the users 250-256) for airline bookings, hotel bookings, courier services, and visa applications. The administrative user(s) 254 may search for prices related to these requests. The administrative user(s) 254 may select a particular booking and submit it to the finance user(s) 252 for approval thereby.

The administrative user(s) 234 and 254 may each perform portions of a method 900 illustrated in FIG. 12 and described below.

### HR User(s)

Referring to FIG. 4, the HR user(s) 236 and 256 are responsible for adding individuals as employees (e.g., the employees 240 illustrated in FIG. 5) of the companies 153A and 153B, respectively. This process adds a record for each employee in the database 126 (see FIG. 1) and associates the employee with his/her employer. For the sake of brevity, the functions performed by the HR user(s) 236 are described below. However, the HR user(s) 256 perform substantially similar functions with respect to the second company 153B.

The HR user(s) 236 may pay employees' salaries (as approved by the operations and finance users 230 and 232). The HR user(s) 236 may manage an employee's leave days and pay the employee for such leave days (after approved by the finance user(s) 232). The HR user(s) 236 may maintain a leave table or database within the database 126 (see FIG. 1) that records, for each of the employees 240, days of leave available in a year, days of leave taken, and the balance of days available.

The HR user(s) 236 may confirm an employee's employment status and the employee's salary (or income) in response to requests received via the computing system 120 from other users. For example, when an employee applies for a visa, the visa agency (also a user of the computing system 120) may send a confirmation request (via the computing system 120) to the HR user(s) 236 requesting confirmation of employment status and income. Such confirmation requests may be sent by any user of the computing system 120. The HR user(s) 236 may receive requests for employment certificates for former employees from a background verification company.

### Employees

Referring to FIG. 5, the HR user(s) 236 connect (or associate) the first company account 222 with the employees 240. The employees 240 are listed in the database 126 as employees of the first company 153A and may request products and/or services using the first company account 222. For example, the employees 240 may request airplane tickets for business trips, submit applications for business visas, and the like. Additionally, the employees 240 may submit claims using the computing system 120. The first company 153A may pay salaries and make other payments to the employees 240 via the computing system 120. Thus, after the HR user(s) 236 have added the individual IND2 as one of the employees 240 (see FIG. 5), the individual IND2 may use the computing system 120 to receive a salary and submit claims.

By way of an example, referring to FIG. 4, the individual IND2 (see FIG. 1) may be one of the employees 240 (see FIG. 5) of the first company 153A (see FIG. 1). Each of the employees 240 has two accounts, a personal account (e.g., the second individual account 228) and an employee company account (e.g., an employee company account 268). The personal account may be used to make personal purchases and the employee company account may be used to perform company duties and request reimbursement for business expenses. By way of non-limiting examples, the individual IND2 may submit requests for business visa applications, airplane tickets, hotel bookings for business trips, and courier services through the employee company account 268.

The employees 240 (see FIG. 5) may be divided into various departments based on their job functions. The employees 240 have the option to log on to either their personal account (e.g., the second individual account 228) or the employee company account (e.g., an employee company account 268) using the same email and password. When the individual IND2 logs in the second individual account 228, the individual IND2 may access the funds in the second individual account 228, search quotes, and pay for personal expenses.

### Visa Agency Example

One or more of the entities 150 (see FIG. 1) may be a governmental visa agency. For example, the second company 153B may be a governmental visa agency and the computing system 120 may at least partially implement a visa application process. The operation user(s) 250 may enter (into the computing system 120) a description of types of visas available and their associated prices using block 510 of the method 500 illustrated in FIG. 8.

Applicants (e.g., the individual IND1) may request a visa by viewing the descriptions (block 515) and entering an application (block 520) for the desired visa. When one of the individuals 160 (e.g., the individual IND1) applies for a visa, the individual IND1 uploads documents and may input the user IDs of other users 110 as references for direct confirmation.

The operation user(s) 250 receive the application for a visa from the individual IND1 (in block 525 of the method 500). The operation user(s) 250 may verify and screen applicants. The operation user(s) 250 may receive appointments for biometrics via the computing system 120. The second company 153B may receive (via the computing system 120) bank statements directly from one of the banks 132 used by the individual IND1, employment status from an employer of the individual IND1, and verification of income direct from the HR users of the employer of the individual IND1. By way of another example, the second company 153B may confirm (via the computing system 120) the assets of the individual IND1 known by other users 110 (e.g., local government bodies, deeds offices, and the like). Thus, the computing system 120 may eliminate the need for the individual IND1 to have bank statements stamped by the bank 133A for submission during the visa application process.

The operation user(s) 250 accepts the application for the visa in block 525. When a country requires that an individual guarantee a certain amount of funds before a visa will be issued, in block 530, the computing system 120 instructs the first bank 133A to freeze such funds as part of the visa application process. Then, in block 535, the applicant is notified of the acceptance of the application and/or freezing of the funds. At least a portion of the method 400 may also be performed during the visa application process. For example, the computing system 120 may instruct the first bank 133A to unfreeze the funds (in block 725 of the method 400) at the prescribed time (e.g. upon leaving the country).

### Academic Institution Example

One or more of the entities 150 (see FIG. 1) may be an academic institution. For example, the first company 153A may be academic institution and the operation user(s) 230 may enter (into the computing system 120) descriptions of programs offered by the institution and fees for each program using block 510 of the method 500 illustrated in FIG. 8. Those of the users 110 wishing to participate in one of the programs may view the descriptions (block 515) and indicate a desire to participate or enter an application (block 520). In optional block 525, the operation user(s) 230 may receive the applications (through the computing system 120) and participate in selection of applicants.

The first company 153A may use the descriptions provided by a governmental visa agency (e.g., the second company 153B) to quote the fees for student visas to international students. After obtaining consent from a student, the second company 153B may obtain information (e.g., student offer letters) directly from the academic institution (e.g., the first company 153A) via the computing system 120.

Other users 110 may receive direct confirmation via the computing system 120 from the academic institution regarding the student.

As mentioned above, the individuals 160 may apply to the academic institution via the computing system 120. The academic institution may retain all applications submitted via the computing system 120 and criteria used for selection. When applying, students may enter a user ID of a guardian or sponsor. Students may connect with the academic institution in the same way that the companies connect with employees.

One of the users 110 (e.g., guardian or sponsor) may use the user ID associated with a student user (and a student number) and the user ID associated with the academic institution to pay fees and other costs for the student user at the academic institution.

The operation user(s) 230 may receive requests for academic confirmations for present or former students from third parties (e.g., background verification entities, described below). In response to such requests, the operation user(s) 230 may send academic confirmations to the third parties after consent is obtained from the present or former student. The operation user(s) 230 may post results (e.g., grades, test results, and the like) for students via the computing system 120 if such students wish to receive these results via the computing system 120. The students may also grant permission to other users (e.g., guardians, sponsors, and the like) to view the results.

### Airline Example

One or more of the entities 150 (see FIG. 1) may be an airline. For example, the first company 153A may be an airline. The operations user(s) 230 may list flights and their associated airfares using block 510 of the method 500 illustrated in FIG. 8. The operation user(s) 230 may also manage flight bookings. The operation user(s) 230 may upload a list of people considered to be dangerous (e.g., a no-fly list) and these people can be prevented from booking a flight. This list can also be shared with other partners (e.g., other users 110 who are also airlines). The operation user(s) 230 may upload a list of meals and other items sold by the airlines.

Using information entered by the operation user(s) 230, the individuals 160 may use the computing system 120 to do one or more of the following:
1. Book flights;
2. Select meals, seats, luggage being checked or carried on, etc.;
3. Pay luggage fees;
4. Select other individuals (one or more of the users 110, such as family, hotels, and friends) to receive updates via the computing system 120 regarding flight information (e.g., check-in information, departure information, landing information, delay information, etc.);
5. Shop for inflight products before (e.g., days before) the flight; and
6. Read inflight magazines before the flight.

When one of the users 110 (e.g., the individual IND2) shops for and purchases one or more inflight products before the flight, the prices of the product(s) is frozen and released only when the individual IND2 checks-in. The individual IND2 may receive the product(s) onboard the flight.

### Supermarket Example

One or more of the entities 150 (see FIG. 1) may be a supermarket. For example, the first company 153A may be a supermarket. The operation user(s) 230 may list descriptions of products and their associated prices using block 510 of the method 500 illustrated in FIG. 8. Customers (e.g., the individual IND2) may order groceries by viewing the descriptions (block 515) and indicating a desire to purchase one or more of the groceries (block 520). In optional block 525, the operation user(s) 230 may receive and accept the purchase. The operation user(s) 230 may also bill customers. Then, in block 530, the computing system 120 instructs the bank 133B used by the individual IND2 to transfer the funds from the second individual account 172B to the first company account 170A. Finally, in block 535, the individual IND2 may be notified of the purchase and/or fund transfer.

### Mobile Network Service Provider Example

Referring to FIG. 1, one or more of the entities 150 (see FIG. 1) may be a mobile network service provider. For example, the first company 153A may be a mobile network service provider. The individuals 160 (which include the operation user(s) 230) may travel using a visa (received via the computing system 120) and air tickets (booked via the computing system 120).

Additionally, the individuals 160 may use the computing system 120 to apply for a subscriber identification module (“SIM”) card before departure. The individuals 160 may use the computing system 120 to search for service providers located at the destination airport and apply for the SIM card before leaving the country. The individuals 160 may specify the size of the SIM card (e.g., nano, micro sim, etc.). The cost of the SIM card (or the SIM charge) may be debited (by the computing system 120) immediately upon request and the individual may receive a mobile number in advance that can be shared with other users. The individual may buy data packages using the computing system 120 in advance of the flight and the computing system 120 may debit any costs for the data packages when the individual checks in. Upon arriving at the airport, the individual may produce a passport and collect the SIM card. Individuals may also pay bills and buy services from mobile service providers using the computing system 120.

### Healthcare Facility Example

One or more of the entities 150 (see FIG. 1) may be a healthcare facility (e.g., a hospital). For example, the first company 153A may be a healthcare facility. The operation user(s) 230 may enter or upload descriptions of services (medical checks, vaccines, etc.) offered at the hospital using block 510 of the method 500 illustrated in FIG. 8. The users 110 may schedule an appointment by viewing the descriptions (block 515) and indicating a desire for an appointment (block 520). The entities 150 may schedule appointments (medical checks and vaccines before employment) for their employees using the computing system 120. The individuals 160 may schedule appointments for personal consultations using the computing system 120.

By way of an example, the individual IND2 may indicate a desire for an appointment. In block 530, the computing system 120 instructs the second bank 133B used by the individual IND2 to freeze sufficient funds in the second individual account 1726 to cover the cost of the appointment. In block 535, the individual IND2 may be notified of the appointment and/or freezing of the funds.

At least a portion of the method 400 illustrated in FIG. 7 may also be performed. For example, the computing system 120 may instruct the second bank 1336 to unfreeze the funds (in block 425 of the method 400) after the appointment has been completed. Then, the computing system 120 transfers the unfrozen amount to the first company account 170A of the first company 153A.

Doctors may use the computing system 120 to view their appointment schedules and confirm attendance of patient. Once confirmation is completed, doctors may use the computing system 120 to select tests to be performed. The individual IND2 may view the tests and their total cost. The individual IND2 may use the computing system 120 to search for other cheaper healthcare facilities or medical centers for the tests to be conducted. When tests are completed, the individual IND2 is notified via the computing system 120.

The healthcare facility may be connected to medical insurance companies via the computing system 120 allowing individuals (or patients) to search for healthcare facilities or medical centers that accepts their medical insurance. For example, a user may enter the user ID assigned by the computing system 120 to the user's medical insurance company and search for healthcare facilities or medical centers that accept the relevant medical insurance. When the individual IND2 schedules an appointment, the operations users 230 of the first company 153A may view the medical coverage of the individual IND2 and the maximum amount(s) covered. Thus, when the operations user(s) 230 bill the individual IND2, the operations user(s) 230 bill only an amount that will be covered by the insurance company. The amount billed and the services provided are confirmed online by the individual IND2. Therefore, claims forms are not necessary and need not be completed (e.g., manually) by either the individual IND1 or the first company 153A. Also, the individual IND2 has access to a soft copy of all the receipts using the second individual account 228.

### Government Agency (or Department) Example

One or more of the entities 150 (see FIG. 1) may be a government agency or department. For example, the first company 153A may be a government agency or department. The operation user(s) 230 may list descriptions of services and/or products (e.g., licenses, fines, permits etc.) and their associated prices using block 510 of the method 500 illustrated in FIG. 8. The individuals 160 (e.g., the individual IND1) may view (block 515) and indicate a desire to purchase one or more of these services and/or products (block 520). The individual IND1 may also submit requirements or reference another user (e.g. bank) which will give direct confirmation to the first company 153A. In optional block 525, the operation user(s) 230 may receive and accept the purchase. Then, in block 530, the computing system 120 instructs the bank 133A used by the individual IND1 to transfer the funds from the first individual account 172A to the first company account 170A. Finally, in block 535, the individual IND1 may be notified of the purchase and/or fund transfer.

The operation user(s) 230 may upload a list of persons of interests (e.g., wanted criminals, people on bail, and the like). The persons of interests may be prevented from booking tickets on a flight (even though the individual IND1 has the right to make such a reservation).

### Local Government Authority Example

One or more of the entities 150 (see FIG. 1) may be a local governmental authority or utility. For example, the first company 153A may be a local governmental authority or utility. The operation user(s) 230 may enter bills or invoices that are sent to one of the users 110 (e.g., the individual IND2) in block 610 of the method 600 illustrated in FIG. 9. In block 615, the individual IND2 reviews and approves the invoice for payment. Then, in block 620, the invoice amount is transferred from the second individual account 1726 to the first company account 170A. Lastly, the first company 153A and/or the individual IND2 may be notified of the transfer.

The individual IND2 may pay the invoice anywhere in the world instantly using the user ID of the first company 153A and an account number (e.g., assigned by an electrical utility to the individual). For example, an individual in Singapore may pay the electricity bill instantly on his behalf or on behalf of someone else in the USA.

By way of another non-limiting example, individuals may pay parking fees using the computing system 120 without paying a parking meter. Referring to FIG. 8, the operation user(s) 230 (see FIG. 4) may list parking locations and their associated parking fees using block 510 of the method 500. The individual IND2 may search for a desired parking location (e.g., by viewing the descriptions in block 515) and may indicate a desire to rent the desired parking location (block 520). The individual IND2 may also identify a vehicle that will be parked in the desired parking location or the computing system 120 may already have the vehicle information. Then, in block 530, the computing system 120 instructs the bank 133B used by the individual IND2 to transfer the funds from the second individual account 172B to the first company account 170A. Finally, in block 535, the individual IND2 may be notified of the purchase and/or fund transfer.

FIG. 10 is a flow diagram of a method 700. In first block 710, the parking fee is received by the first company account 170A for a selected parking location from the individual IND2. After block 530 of the method 500, the first company 153A has received the parking fee. Thus, block 710 is satisfied.

In next block 715, the software 124 (executed by the computing system 120) updates the database 126. The database 126 stores a list of vehicles (e.g., cars) for which parking fees have been paid at that particular time.

In block 720, a parking enforcement officer enters an identifier (e.g., a license plate number) of a particular vehicle into the computing system 120 and the software 124 queries the database 126 for the identifier.

In decision block 725, the computing system 120 determines whether the parking fees have been paid for the vehicle. The database 126 may indicate the parking fees have been paid for the vehicle if the vehicle appears in the database 126. The decision in decision block 725 is “YES,” when the computing system 120 determines the parking fees have been paid for the vehicle. Otherwise, the decision in decision block 725 is “NO.”

When decision in decision block 725 is “YES,” the method 700 terminates. Otherwise, in block 730, the parking enforcement officer issues a parking ticket. Then, the method 700 terminates.

Thus, as explained above, the individual IND2 may pay parking fees without paying a parking meter, printing a receipt, or displaying the receipt on the vehicle (e.g., on the dashboard or in a window).

### Hotel Example

One or more of the entities 150 (see FIG. 1) may be a hotel. For example, the first company 153A may be a hotel. The operation user(s) 230 enter or upload room, meal, drink, and/or other prices (block 510 of the method 500 illustrated in FIG. 8) and these prices are viewable by other users (block 515). The individual IND2 may book a hotel room (block 520) and (in block 530) the cost of the room is frozen in the second individual account 1726. The individuals 160 may view their selected rooms and the view from that room prior to booking the room.

At least a portion of the method 400 illustrated in FIG. 7 may also be performed. For example, the computing system 120 may instruct the first bank 133A to unfreeze the funds (in block 425 of the method 400) as the costs are incurred (e.g., the room charge may be released each day as the guest stays at the hotel). Other costs (such as food, laundry, etc.) may be charged as incurred and the first company 153A may use block 610 of the method 600 to bill the individual IND2. The individual IND2 receives notification of the charge and the individual IND2 confirms payment (block 615) on their computing device 163B (e.g., through a pin code). The individuals 160 may automatically receive air miles (if the hotel is partners with the individual airlines or others) as the individuals 160 pay for any costs incurred during the stay at the hotel.

The operation user(s) 230 may receive (via the computing system 120) notifications of flight details and status information with respect to hotel guests if the guests desire (e.g., those guests that require airport pick-up by the hotel). The operation user(s) 230 may schedule staff according to their work or duties (e.g., housekeeping, laundry, etc.) using the computing system 120.

### Bank Example

One or more of the entities 150 (see FIG. 1) may be a bank. For example, the first company 153A may be a bank. The operation user(s) 230 may enter (into the computing system 120) descriptions of product(s) and/or service(s) (e.g., loans and investments options) available to the users 110. The operation user(s) 230 may receive requests for confirmations and send confirmations via the computing system 120. With the consent of the individuals, the operation user(s) 230 may perform asset and liability searches nationally or internationally using the computing system 120. The operation user(s) 230 may offer hedging services. The operation user(s) 230 may review applications (e.g., for loans) submitted. The operation user(s) 230 may enter or upload exchange rates used by the computing system 120.

### Recruiting Example

Referring to FIG. 6, the HR user(s) 236 (see FIG. 4) may use the method 300 when recruiting personnel. For example, when the first company 153A (see FIG. 1) needs to recruit staff, in blocks 310 and 315, the HR user(s) 236 may issue a request for quote to recruitment agencies and appoint a recruitment agency in blocks 330-345. When the recruitment agencies are entering quotes (in blocks 320 and 325), they may quote a fixed amount or include a retention fee. A retention fee will be a fee paid by the first company 153A if the recruit stays with the first company 153A for an agreed period of time.

In block 350, both the retention fee (if applicable) and the fixed quote amount are frozen by the first bank 133A after the quote has been selected. When the first company 153A selects a quote (in block 330-345) with a retention fee clause, the retention fee is held by the bank 133A during the specified retention period. During this period, the retention fee earns a specified interest rate for the recruitment agency. The fixed quote amount is released and paid (block 425 of the method 400 illustrated in FIG. 7) after the first company 153A, the recruitment agency, and the job candidate confirm (via the computing system 120) that a job candidate has signed a contract of employment.

The recruitment agencies may search for job candidates on the computing system 120. Those of the users 110 may list themselves on the computing system 120 (as searchable and) seeking employment. Academic institutions that are users of the computing system 120 may post a list of recent graduates that is viewable by the recruitment agencies. This list may show only a student number, qualifications, and graduation date. However, only recruitment agencies with appointed quotes may search for job candidates and allowed to view contact details of the candidates.

Each of the recruitment agencies may contact only a predetermined number of candidates for each quote for which the recruitment agency has been appointed.

Once the recruitment agency identifies a job candidate, the recruitment agency may schedule an interview (using the computing system 120) between the candidate and the HR user(s) 236 of the first company 153A. The HR manager may use the computing system 120 to invite other relevant managers to join the interviews and these invitees may select one of the candidates. Records of the interviews and feedback entered by invitees is available on the company user account 222. The HR user(s) 236 (and/or other users) may confirm attendance at interviews and the selection of a job candidate (referred to as the “selected candidate”). The selected candidate may not list themselves on the computing system 120 (as searchable and) seeking employment for at least a predetermined period of time (e.g., six months).

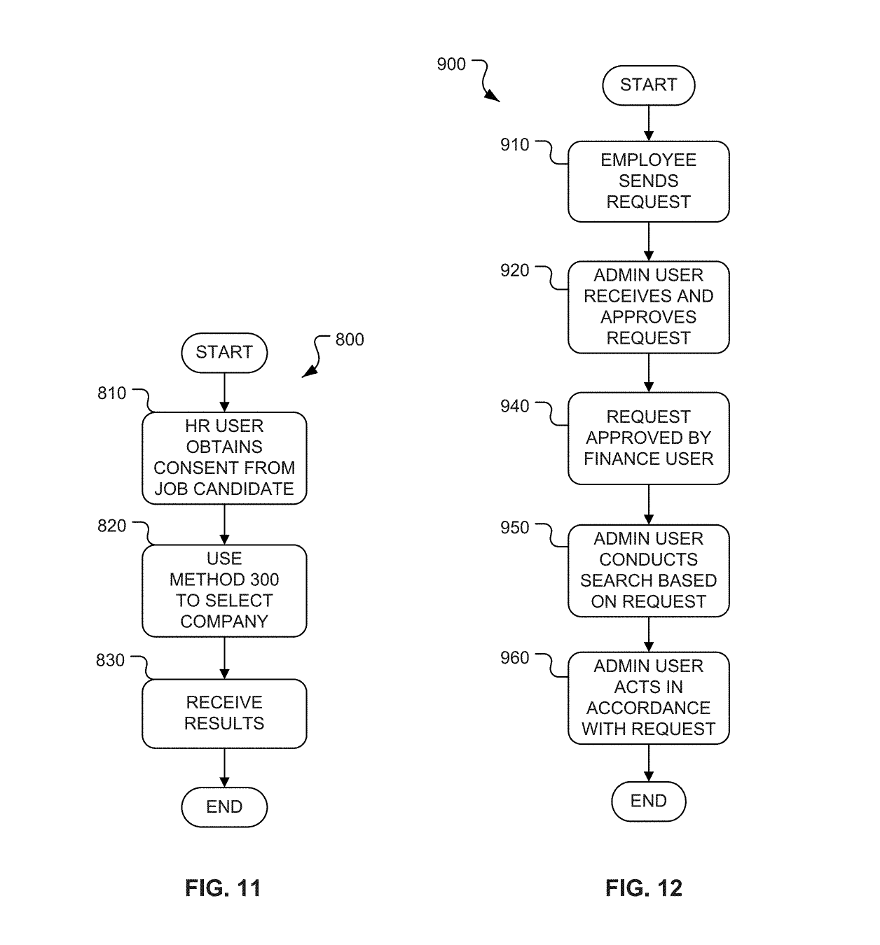

Once the candidate is selected, the HR user(s) 236 may perform Background Verification (BV) checks using a method 800 illustrated in FIG. 11. In first block 810, the HR user(s) 236 obtains consent from the candidate for the BV checks via the computing system 120. Next, in block 820, the HR user(s) 236 uses the method 300 to select a BV company to perform the BV checks.

At this point, the BV company can start performing the BV checks on the candidate using the computing system 120. For example, the BV company can send communications including requests for background information to other users. Such users may include law enforcement (and the communication may request criminal records), one or more previous employers (and the communication may request confirmation of employment), one or more academic institutions (and the communication may request confirmation of academic qualifications), and the like.

In block 830, the HR user(s) 236 receive the results of the BV checks via the computing system 120. The results may be a simple pass or fail indication.

After the candidate is selected, the HR user(s) 236 may use the method 800 illustrated in FIG. 11 to select a medical center to perform medical checks and/or schedule for vaccines. The first company 153A may only conduct medical checks permitted by the laws of the relevant country.

In first block 810, the HR user(s) 236 obtains consent from the candidate for the medical checks and/or vaccines via the computing system 120. Next, in block 820, the HR user(s) 236 uses the method 300 to select a healthcare provider to perform the medical checks and/or administer the vaccines.

At this point, the job candidate schedules an appointment for the medical check and/or administration of the vaccines. The HR user(s) 236 may schedule employees (e.g., pilots) that require regular medical checks.

In block 830, the HR user(s) 236 receive the results of the medical checks and/or confirmation of the administration of the vaccines via the computing system 120. The results may be a simple pass or fail indication.

The computing system 120 may record one or more of the following pieces of information and associates this information with the relevant account(s) on the computing system 120:
1. Identities (e.g., user IDs) of job candidates interviewed;
2. Users selected using quote process(es) for each stage (appointment of recruitment agencies, BV companies, healthcare facilities, etc.);
3. Results of BV checks;
4. Medical tests performed and/or results of those tests; and
5. Details related to acceptance of contract.

### Employee Request Example

As mentioned above, the employees 240 (see FIG. 5) may submit requests using the computing system 120. For example, the employees 240 may submit business visa applications, requests for airplane tickets, requests for hotel bookings for business trips, and requests for courier services.

FIG. 12 is a flow diagram of a method 900 that may be used to process employee requests. For ease of illustration, the method 900 will be described with respect to the individual IND2, who, in this example, is one of the employees 240 of the first company 153A.

In first block 910, the individual IND2 submits a request on the computing system 120 using the employee company account 268.

In next block 920, the administrative user(s) 234 (see FIG. 4) review and approves the request on the computing system 120. The computing system 120 sends this approval to the finance user(s) 232 (see FIG. 4).

In next block 940, the finance user(s) 232 (see FIG. 4) review and approves the request on the computing system 120.

In next block 950, the administrative user(s) 234 (see FIG. 4) conducts a search on the computing system 120 based on the request. For example, the administrative user(s) 234 may search for airfares, hotel rooms, etc.

In next block 960, the administrative user(s) 234 (see FIG. 4) acts in accordance with the request. For example, the administrative user(s) 234 may book a flight, a hotel room, and the like. By way of another non-limiting example, the administrative user(s) 234 may apply for a visa, hire a courier service, and the like.

### Laws and Regulations Example

Referring to FIG. 1, various government ministries (e.g., those associated with the sub-organization accounts 290A-290C illustrated in FIG. 13) may list laws and regulations (in the computing system 120) according to different industries and sectors over which the ministries have jurisdiction. This list may be viewed by the user 110 (e.g., the companies 153A and 153B) as applicable. The following are examples of the types of information that a ministry or department may list:

a. a ministry of health may list medical checks required for employment and/or visas, which may be linked to a medical center section.

b. an immigration ministry may post types of visas, which may be be linked with the visa section.

c. a ministry of labor may post minimum wage, minimum working hours, maximum working hours, standard contract for certain employees (e.g., helpers), which may be viewable by applicable companies.

d. ministries may post licenses required by companies. When companies obtain these licenses, they will be able to view the registration dates and expiry dates from all of the government departments. The computing system 120 may also display costs related to the licenses (e.g., cost of renewing the licenses). The computing system 120 may also send reminders when the expiry date approaches.

### Compliance Certificate Example

The computing system 120 may help confirm compliance with the laws and regulations. For example, the computing system 120 may record or store compliance certificates. The follow process may be used by the computing system 120 to obtain a compliance certificate. For ease of illustration, the process will be described as being performed by the first company 153A. A head of a legal department (e.g., a general counsel) of the first company 153A allocates compliance with laws and/or regulations to relevant users (e.g., one or more of the operations, finance, administrative, and HR users 230-236). The relevant users confirm compliance (by entering confirmations into the computing system 120). Then, the board of directors (described below) of the first company 153A may enter final confirmations into the computing system 120. Thus, using this process, a two level compliance certificate is obtained by the computing system 120.

### Blocking Purchases Example

The users 110 may set their accounts to block certain purchases for certain reasons (e.g., users belonging to a certain religion can block pork, beef, or alcoholic items). Purchases may also be blocked for health reasons. For example, a user who is allergic to nuts may set the user's account to not purchase anything that includes nuts.

### Board of Directors Example

Referring to FIG. 4, the finance users 232 and 252 may set up Boards of Directors for the companies 153A and 153B. For example, the computing system 120 may display a tab for this purpose. For example, the finance user(s) 232 may use the tab to request that one of the individuals 160 (see FIG. 1) join the board of directors of the first company 153A. This request may be confirmed by the operations user(s) 230, the administrative user(s) 234, and HR user(s) 236 before the individual is added into the board of directors. Typically, users to be included in the board of directors include a legal secretary of the first company 153A and other relevant users who attend board meetings. After the meetings, the minutes may be entered into the computing system 120 and shared with the board members on the computing system 120. The members can comment on the minutes and the sender can edit them. Once agreed upon, the members may confirm the minutes as final using the computing system 120. These minutes may only be shared by a chairperson of the board. The computing system 120 may also maintain a track register that shows a list of users with which the minutes have been shared.

### Wills Example

The users 110 may write and file wills (using the computing system 120 and, optionally, lawyers) with the relevant government department. The individuals 160 may draft wills that lawyers may confirm using the computing system 120. Assets listed in a will as being owned by an individual (e.g., the individual IND4) may be listed or stored on the computing system 120. When there is a change in ownership of an asset or anything happens, the heir or beneficiary may send a notification using the computing system 120 to the individual (e.g., the individual IND4) and/or the lawyer representing the individual. The notification may indicate that the will needs to be updated because of the change in ownership that occurred. By way of another non-limiting example, the computing system 120 may send a notification to a beneficiary when the beneficiary reaches a predetermined age if the beneficiary is set (according to a will stored on the computing system 120) to inherit a certain asset if the beneficiary is below the predetermined age.

Depending upon the implementation details, the computing system 120 (including the software 124 and, optionally, the database 126) may provide one or more of the following advantages over the prior art.

The computing system 120 may provide a convenient way of making instant payments anywhere in the world using only a unique user ID. Thus, there is no need for bankcards, swift codes, or inputting other information (e.g., an account number, the name of the individual, etc.). This convenience is further enhanced by the funds being available via banks (e.g., accessible at automated teller machines (“ATMs”), online, or at the banks) as cash.

The computing system 120 may be used to provide direct confirmations to the users 110. For example, the users 110 may obtain direct confirmation (e.g., documents) from relevant parties. Further, the computing system 120 may be used to obtain consent (if necessary) from relevant parties. For example, the computing system 120 may be used (e.g., by visa agencies or BV companies) to obtain bank statements directly from a bank or confirmation of academic qualifications directly from a university. By way of another non-limiting example, the computing system 120 may be used (e.g., by BV companies) to request a criminal records search of a candidate (individual user) directly by a police agency. By way of another non-limiting example, the computing system 120 may be used (e.g., by banks) to search a user's assets and/or liabilities to assess worthiness. By way of another non-limiting example, the computing system 120 may be used (e.g., by banks) to search deeds to confirm ownership of a property or asset before the property or asset is purchased.

The computing system 120 may be used by healthcare facilities (e.g., hospitals) to invoice insurance companies.

The users 110 may use the computing system 120 to apply for SIM cards in advance of traveling and/or to select other users (e.g., relatives and friends) to receive flight information and/or status. The users 110 may use the computing system 120 to search for items from nearby supermarkets, compare prices, make purchases, and have items delivered to their homes. The users 110 may use the computing system 120 to pay parking fees (e.g., using their mobile devices). A first user may use the user ID of a different second user to make a purchase anywhere in the world as long as the second user confirms the purchase on one of the computing devices 162 (e.g., a mobile device) wherever the second user is located.

The computing system 120 may provide improved transparently. For example, the user 110 may seek quotes from other users in a transparent manner. The quotes received may be viewable by all or a relevant portion of the users 110 at the same time thus no one will be able to tamper with the quotes. These functions are available to governmental organizations (e.g., with government accounts like the main government account 280 or the sub-organization accounts 290A-290C illustrated in FIG. 13). Referring to FIG. 1, the computing system 120 retains records of decisions (e.g., selection of quotes) making this information available for future reference, which enhances transparency. The auditor function helps improve transparency, accountability, and reduces corruption.

The computing system 120 may help reduce costs. For example, because the users 110 may seek quotes in a transparent manner, they will be able to reduce their costs. Transfer or transaction costs may be reduced (saving the users 110 money) because the users 110 are grouped together (by the computing system 120) making business transactions between different users simpler and/or easier.

The computing system 120 may help reduce the number of documents printed because most transactions (and related documents) will be available online via the computing system 120. The users 110 may share documents via the computing system 120 with any other user (e.g., companies). For example, a visa or permit agency may obtain documents directly online via the computing system 120 from another user (e.g., one of the banks 132). Thus, there is no need to obtain a bank statement stamped by the bank, which must be first printed and then stamped. This saves both paper and time. By way of another non-limiting example, medical centers do not need to print and complete documents (e.g., medical receipts, claim forms, etc.) to submit claims to medical insurance companies. By way of yet another non-limiting example, as explained above, receipts for parking fees do not need to be printed and placed on vehicles (e.g., on dashboards).

The computing system 120 may reduce dependence on physical currently or notes and coins, which helps protect the environment.

The computing system 120 guarantees payment after delivery of products or services. One of the challenges of offering products or services to international customers or unknown local customers is the uncertainty of receiving payment after the products or services have been delivery. Because the computing system 120 guarantees payment for all quotes entered and selected using the method 300 illustrated in FIG. 6, this uncertainty is no longer a challenge. Thus, markets may be expanded beyond borders, which may result in better quality products, cheaper products, and/or increased profits for suppliers.

Referring to FIG. 1, the computing system 120 implements a BV process that may be better and more thorough because a BV company may (after obtaining the individual's consent) search criminal records locally and/or globally. Due diligence with respect to companies may be easier and/or less costly because direct confirmations may be obtained using the computing system 120. Persons of interest lists can be shared by concerned and/or relevant users of the computing system 120. For example, airlines and/or government agencies may share a list of individuals considered to be dangerous (e.g., the no-fly list). Thus, the computing system 120 may help protect people by providing better security controls.

### Computing Device

FIG. 14 is a diagram of hardware and an operating environment in conjunction with which implementations of the one or more computing devices of the system 100 may be practiced. The description of FIG. 14 is intended to provide a brief, general description of suitable computer hardware and a suitable computing environment in which implementations may be practiced. Although not required, implementations are described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that implementations may be practiced with other computer system configurations, including hand-held devices, multiprocessor systems, microprocessor-based or programmable consumer electronics, network PCs, minicomputers, mainframe computers, and the like. Implementations may also be practiced in distributed computing environments where tasks are performed by remote processing devices that are linked through a communications network. In a distributed computing environment, program modules may be located in both local and remote memory storage devices.

The exemplary hardware and operating environment of FIG. 14 includes a general-purpose computing device in the form of the computing device 12. Each of the computing devices of FIG. 1 (including the computing systems 120, 130, and 152 and the computing devices 162) may be substantially identical to the computing device 12. By way of non-limiting examples, the computing device 12 may be implemented as a laptop computer, a tablet computer, a web enabled television, a personal digital assistant, a game console, a smartphone, a mobile computing device, a cellular telephone, a desktop personal computer, and the like.

The computing device 12 includes a system memory 22, the processing unit 21, and a system bus 23 that operatively couples various system components, including the system memory 22, to the processing unit 21. There may be only one or there may be more than one processing unit 21, such that the processor of computing device 12 includes a single central-processing unit (“CPU”), or a plurality of processing units, commonly referred to as a parallel processing environment. When multiple processing units are used, the processing units may be heterogeneous. By way of a non-limiting example, such a heterogeneous processing environment may include a conventional CPU, a conventional graphics processing unit (“GPU”), a floating-point unit (“FPU”), combinations thereof, and the like.

The computing device 12 may be a conventional computer, a distributed computer, or any other type of computer.

The system bus 23 may be any of several types of bus structures including a memory bus or memory controller, a peripheral bus, and a local bus using any of a variety of bus architectures. The system memory 22 may also be referred to as simply the memory, and includes read only memory (ROM) 24 and random access memory (RAM) 25. A basic input/output system (BIOS) 26, containing the basic routines that help to transfer information between elements within the computing device 12, such as during start-up, is stored in ROM 24. The computing device 12 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM, DVD, or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer-readable instructions, data structures, program modules, and other data for the computing device 12. It should be appreciated by those skilled in the art that any type of computer-readable media which can store data that is accessible by a computer, such as magnetic cassettes, flash memory cards, solid state memory devices (“SSD”), USB drives, digital video disks, Bernoulli cartridges, random access memories (RAMs), read only memories (ROMs), and the like, may be used in the exemplary operating environment. As is apparent to those of ordinary skill in the art, the hard disk drive 27 and other forms of computer-readable media (e.g., the removable magnetic disk 29, the removable optical disk 31, flash memory cards, SSD, USB drives, and the like) accessible by the processing unit 21 may be considered components of the system memory 22.

A number of program modules may be stored on the hard disk drive 27, magnetic disk 29, optical disk 31, ROM 24, or RAM 25, including the operating system 35, one or more application programs 36, other program modules 37, and program data 38. A user may enter commands and information into the computing device 12 through input devices such as a keyboard 40 and pointing device 42. Other input devices (not shown) may include a microphone, joystick, game pad, satellite dish, scanner, touch sensitive devices (e.g., a stylus or touch pad), video camera, depth camera, or the like. These and other input devices are often connected to the processing unit 21 through a serial port interface 46 that is coupled to the system bus 23, but may be connected by other interfaces, such as a parallel port, game port, a universal serial bus (USB), or a wireless interface (e.g., a Bluetooth interface). A monitor 47 or other type of display device is also connected to the system bus 23 via an interface, such as a video adapter 48. In addition to the monitor, computers typically include other peripheral output devices (not shown), such as speakers, printers, and haptic devices that provide tactile and/or other types of physical feedback (e.g., a force feedback game controller).

The input devices described above are operable to receive user input and selections. Together the input and display devices may be described as providing a user interface.

The computing device 12 may operate in a networked environment using logical connections to one or more remote computers, such as remote computer 49. These logical connections are achieved by a communication device coupled to or a part of the computing device 12 (as the local computer). Implementations are not limited to a particular type of communications device. The remote computer 49 may be another computer, a server, a router, a network PC, a client, a memory storage device, a peer device or other common network node, and typically includes many or all of the elements described above relative to the computing device 12. The remote computer 49 may be connected to a memory storage device 50. The logical connections depicted in FIG. 14 include a local-area network (LAN) 51 and a wide-area network (WAN) 52. Such networking environments are commonplace in offices, enterprise-wide computer networks, intranets and the Internet. The network 180 (see FIG. 1) may be implemented using one or more of the LAN 51 or the WAN 52 (e.g., the Internet).

Those of ordinary skill in the art will appreciate that a LAN may be connected to a WAN via a modem using a carrier signal over a telephone network, cable network, cellular network, or power lines. Such a modem may be connected to the computing device 12 by a network interface (e.g., a serial or other type of port). Further, many laptop computers may connect to a network via a cellular data modem.

When used in a LAN-networking environment, the computing device 12 is connected to the local area network 51 through a network interface or adapter 53, which is one type of communications device. When used in a WAN-networking environment, the computing device 12 typically includes a modem 54, a type of communications device, or any other type of communications device for establishing communications over the wide area network 52, such as the Internet. The modem 54, which may be internal or external, is connected to the system bus 23 via the serial port interface 46. In a networked environment, program modules depicted relative to the personal computing device 12, or portions thereof, may be stored in the remote computer 49 and/or the remote memory storage device 50. It is appreciated that the network connections shown are exemplary and other means of and communications devices for establishing a communications link between the computers may be used.

The computing device 12 and related components have been presented herein by way of particular example and also by abstraction in order to facilitate a high-level view of the concepts disclosed. The actual technical design and implementation may vary based on particular implementation while maintaining the overall nature of the concepts disclosed.

In some embodiments, the system memory 22 stores computer executable instructions that when executed by one or more processors cause the one or more processors to perform all or portions of one or more of the methods (including the methods 300-900 illustrated in FIGS. 6-12, respectively) described above. Such instructions may be stored on one or more non-transitory computer-readable media.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Accordingly, the invention is not limited except as by the appended claims.

The invention claimed is:

1. A computer-implemented method of grouping bank account holders in different countries under an account, the bank account holders being able to transfer funds or make payments instantly including international transfers using only a recipient User ID and without using a traditional transfer that includes at least one swift code, account number, or IBAN number.

2. The method of claim 1, further comprising:
receiving a purchase request from a first one of the bank account holders to purchase something anywhere in the world using a purchaser User ID associated with a different second one of the bank account holders;
receiving a confirmation of the purchase, from a mobile device operated by the second bank account holder wherever the second bank account holder is located; and
processing the purchase request after receiving the confirmation.

3. A computer-implemented method comprising:
issuing, using a computing system, a request for a quote, the request having been issued by an operations user of a first user;
receiving, by the computing system, approval of the request by a finance user of the first user;
transmitting, by the computing system, the request to a plurality of users, the request being received and reviewed by operations users of the plurality of users;
receiving, by the computing system, a quote from a second one of the plurality of users, the quote comprising a monetary amount;
transmitting, by the computing system, the quote to the first user;
receiving, by the computing system, a selection of the quote from the first user;
receiving, by the computing system, approval of the selected quote by the finance user of the first user;
instructing, by the computing system, a bank to freeze the monetary amount in a first account associated with the first user; and
notifying, by the computing system, the second user of the selection of the quote.

4. The computer-implemented method of claim 3, further comprising:
identifying, by the computing system, a conflict of interest between the first and second users; and
notifying, by the computing system, the first and second users of the conflict of interest.

5. A computer-implemented method comprising:
connecting, by a computing system, a company bank account associated with a company to individual bank accounts each associated with an employee to thereby connect the employee with the company.

6. A computer-implemented method comprising:
connecting, by a computing system, a company account associated with a company to a plurality of accounts associated with a plurality of entities, each of the plurality of entities being a branch, a partner, or an office; and
using the computing system to at least one of (a) share information between the company account and the plurality of accounts, and (b) grant rights associated with the company account to one of the plurality of accounts, one of the rights granted comprising a right to approve payment.

7. The computer-implemented method of claim 6, wherein the company or and the plurality of entities are connected companies, and the method further comprises:
displaying, to a particular one of the connected companies, company information associated with other ones of the connected companies when a right to view the company information was granted to the particular connected company by the other connected companies, the particular connected company being able to approve quotes, approve payments, and generate reports using the company information.

8. A computer-implemented method comprising:
creating, by a computing system, a company account for a company, the company account storing funds divided by functions performed by individual users in the company, the individual users comprising one or more finance users, one or more human resource users, one or more administrative users, and one or more operations users, the one or more finance users being able to allocate the funds.

9. A computer-implemented method comprising:
connecting, by a computing system, day-to-day business activities of a company with funds associated with the company, payments made to a bank account associated with the company, or receipts associated with the company.

10. The computer-implemented method of claim 9, wherein the company is an airline and the day-to-day business activities comprise booking tickets, the tickets being connected with the bank account associated with the airline.

11. The computer-implemented method of claim 9, wherein the company is a hospital and the day-to-day business activities comprise patient bookings and schedules, the bookings and schedules being connected with the bank account associated with the hospital or the funds associated with the hospital.

12. A computer-implemented method comprising:
receiving, by a computing system, consent, from a first user, for a second user to request a confirmation with respect to the first user; and
sending, from the second user, using the computing system, a request for direct confirmation from one or more relevant users, wherein:
the first user is applying for a visa, the second user is a visa agency, the one or more relevant users is a bank, and the request seeks the first user's bank statements and is used to assess the first user's income;
the first user is a company, the second user is an auditor, and the request seeks company financial statements and is used to tender a job;
the second user is a background verification company, the one or more relevant users is an academic institution, and the request seeks confirmation of the first user's academic qualifications;
the second user is a background verification company, the one or more relevant users are law enforcement agencies in a plurality of different countries, and the request seeks criminal records of the first user;
the request is for a deed search conducted before purchasing a property or an asset; or
the second user is an insurance company and the request is sent before payment of an insurance claim and seeks a confirmation related to the insurance claim.

13. A computer-implemented method comprising:
receiving, by a computing system, consent, from a first user, for a second user to search for liabilities and assets of the first user, the search comprising at least one of a deeds search and a search of shareholding structures of companies.

14. A computer-implemented method comprising:
receiving, by a computing system, invoices from medical centers; and
submitting, by the computing system, the invoices to medical insurance companies without users having manually completed claim forms.

15. A computer-implemented method comprising:
scheduling, using a computing system, an appointment for a patients;
displaying, by the computing system, the appointment to a doctor and the patient;
receiving, by the computing system, confirmation that the patient has attended the appointment from the patient, the doctor, and a reception user;
receiving, by the computing system, a list of tests for the patient from the doctor;
displaying, by the computing system, the list of tests to the patient; and
searching, by the computing system, for quotes for the tests; and
scheduling, by the computing system, appointments for the tests.

16. A computer-implemented method comprising:
displaying, by a computer system, a list of parking locations;
receiving, by the computer system, a selection of one of the parking locations and an agreement to pay a fee to rent the selected location for a period of time from a first user;
instructing, by the computer system, a bank to deduct a payment amount from an account held by the first user and deposit the payment amount in a second account held by a second user;
storing, by the computer system, a record of the deposit;
receiving, by the computer system, before expiration of the period of time, a query comprising an identifier of the selected location and an identifier of a vehicle associated with the first user; and
transmitting, by the computer system, an indication that the payment amount has been paid in response to the query thereby confirming payment of the fee without the first user having paid a parking meter, printed a receipt, or displayed the receipt on the vehicle.

17. A computer-implemented method comprising:
Connecting, by a computing system, a company account associated with a company to a plurality of accounts associated with a plurality of branches, the company and the plurality of branched being connected entities; and
receiving, by the computing system, an inquiry from at least one of the connected entities with regard to combining purchases for the purposes of taking advantage of a trade discount offered by a supplier; and
sending, by the computing system, the inquiry to others of the connected entities.

18. A computer-implemented method comprising:
receiving, by a computing system, a quote from a recruitment agency comprising a quote amount, the quote amount comprising at least one of a fixed amount and a retention fee, the retention fee being paid by a company when an employee remains employed by the company for a specified retention period;
receiving, by the computing system, an indication that the quote has been selected;
instructing, by the computing system, a bank to freeze the quote amount as soon as the quote is selected, the recruitment agency searching for candidates who listed themselves as searchable by recruitment agencies, when the quote amount comprises the retention fee, the retention fee being held by the bank during the specified retention period and earns a specified interest rate for the recruitment agency; and
instructing, by the computing system, the bank to unfreeze the retention fee and transfer the retention fee to recruitment agency when the employee, the company, and the recruitment agency confirm that the employee has been employed by the company for at least the specified retention period.

19. A computer-implemented method comprising:
receiving, by a computing system, an instruction to transfer funds from a first user; the instruction identifying at least one second user who must confirm fulfilment of a condition before the transfer;
receiving, by the computing system, confirmation from the at least one second user; and
transferring, using the computing system, the funds after receiving the confirmation.

20. The computer-implemented method of claim 19, wherein the at least one second user comprises lawyers who confirm the fulfilment of the condition, and the condition is a transfer of property.

21. A computer-implemented method comprising:
receiving, by a computing system, a selection of a plurality of users from a particular user, the plurality of users comprising at least one of a family member, a friend, and a hotel; and
sending, by the computing system, flight status information related to a flight scheduled for the particular user to the plurality of users, the flight status information comprising at least one of delays, check-in time, landing time, and alerts regarding progress of the flight.

22. A computer-implemented method comprising:
receiving, by a computing system, a selection of a plurality of users from a student user; and
sending, by the computing system, exam results of the student user and other notifications to the plurality of users.

23. A computer-implemented method comprising:
before a flight operated by an airline, receiving, by a computing system, a selection of an inflight product from a user who is a passenger on the flight;
receiving, by the computing system, an indication that the user has checked into the flight; and
after receiving the indication, transferring, by the computing system, payment for the selected inflight product from an account associated with the user to an account associated with the airline, the user receiving the inflight product onboard the flight.

24. A computer-implemented method comprising:
purchasing airline tickets for a flight to a destination airport via a computing system;
searching, the computing system, for service providers operating at the destination airport;
applying for a subscriber identification module (“SIM”) card, via the computing system, before the flight, the application specifying a size of the SIM card, the computer system immediately debiting a charge for the SIM card from an account associated with the user, the computing system sending a mobile number to the user before the flight, the mobile number being sharable with other users via the computing system; and
applying for a visa using the computing system, the visa being obtained before the flight, the user producing a passport at a departure airport and collecting the SIM card before the flight.

25. The computer-implemented method of claim 24, wherein the user purchases a data package before the flight, the computer system debiting a charge for the data package only when the user checks in to the flight.

26. A computer-implemented method comprising:
receiving, by a computing system, a user ID of a first user from a second user, the second user delegating duties to the first user while the second user is on leave;
receiving, by the computing system, a start date and an end date for the leave; and
sending, by the computing system, a login user ID and a password to the first user, the login user ID and the password being usable by the first user to perform the duties delegated to the first user for a duration of the leave.

27. The computer-implemented method of claim 26, further comprising:
receiving, by the computing system, an indication that the second user would like to receive notifications during the leave; and
sending, by the computing system, the notifications to the second user.

28. A computer-implemented method comprising:
displaying, by a computing system, a database of recently purchased items to security personnel, the security personnel being located at exit points, the security personnel using the database to confirm purchases as customers leave a store thereby eliminating the need to print receipts, the computing system comprising at least one of a mobile telephone carried by one of the customers or a mobile device operated by the security personnel.

29. A computer-implemented method comprising:
receiving, by a computing system, an application for a visa from a user in a country;
instructing, by the computing system, a bank to freezing funds to guarantee payment of at least one fee associated with applying for the visa; and
instructing, by the computing system, the bank to release the frozen funds after the user leaves the country.

30. A computer-implemented method comprising:
conducting, by a computing system, a number of transactions between a plurality of banks, the banks settling any net-payables associated with the transactions among themselves.

31. A computer-implemented method comprising:
receiving, by a computing system, a user ID assigned to a medical insurance company by the computing system; and
searching, by the computing system, for hospitals that accept medical insurance offered by the medical insurance company.

32. A computer-implemented method comprising:
receiving, by a computing system, claims submitted by healthcare practitioners, the claims comprising only at least one of expenses and receipts; and
submitting, by the computing system, the claims to at least one a medical insurance company for payment, thereby eliminating a need for hospitals and users to complete claim forms and submit invoices to the at least one a medical insurance company.

33. A computer-implemented method comprising:
receiving, by a computing system, an indication from a plurality of users that they would like to be searchable by recruitment agencies;
receiving, by the computing system, a selection of a quote submitted by an appointed one of the recruitment agencies;
the appointed recruitment agency searching, using the computing system, the plurality of users and selecting six of the users as job candidates, the recruitment agencies other than the appointed recruitment agency being able to search and view qualifications of the plurality of users using the computing system; and
the appointed recruitment agency viewing, using the computing system, contact details of the job candidates.

34. A computer-implemented method comprising:
conducting, by a computing system, a plurality of transactions; and
recording, by the computing system, information related to the plurality of transactions, the information comprising at least one of:
search criteria indicating how quotes were searched,
results of each search,
companies from which quotes were requested,
companies from which quotes were not requested,
quotes received,
selected quotes,
identification of user who selected each quote,
identification of user who approved each quote,
invoices received,
users who approved each of the invoices.

35. A computer-implemented method comprising:
receiving, by a computing system, an indication from a plurality of users that they would like to be searchable by recruitment agencies; and
excluding, by the computing system, any of the plurality of users from searches conducted by the recruitment agencies using the computing system who were appointed within a specified period of time.

36. A computer-implemented method comprising:
displaying, by a computing system, a tab labeled “Auditors Tab” to a finance user, the finance user using the tab to assign viewing rights to email addresses associated with auditors, the auditors logging onto the computing system using the email addresses, the auditors only being able to view and generate reports on a company account after the auditors have logged on using the email addresses;
receiving, by the computing system, an email address of an auditors manager input by the finance user; and
sending, by the computing system, to the auditors manager a log of activities of the auditors for a month, the log comprising when the auditors logged on, what the auditors viewed, and reports generated by the auditors.

37. The computer-implemented method of claim 36, wherein if the auditors work for a government department, the auditors manager is an Auditor General.

38. A computer-implemented method comprising:
for each of a plurality of job candidates, confirming, using a computing system, attendance by the job candidate at a job interview, the confirmation being entered by those employees who interviewed the job candidate;
performing, using the computing system, a plurality of stages, each stage comprising performing a quote process, the stages comprising appointing a recruitment agency and a background verification (“By”) company;
indicating, using the computing system, a selection of one of the plurality of job candidates as a new hire; and
storing information related to the selection of the new hire, the information comprising at least one of:
identities of those of the plurality of job candidates interviewed,
the quote process performed for each stage,
results of a BV process performed by the BV company,
any medical tests performed, and
acceptance of a contract.

39. A computer-implemented method comprising:
posting, using a computing system, a list of recent graduates by academic institutions, the list comprising only a student number, qualifications, and graduation date; and
performing, using the computing system, an appointment process whereby at least one of a plurality of recruitment agencies is appointed, only the at least one appointed recruitment agency being able to view the list.

40. A computer-implemented method comprising:
creating a main government account for a government, the main government account storing funds divided by functions performed by individual users in the government, the individual users comprising one or more finance users, one or more human resource users, one or more administrative users, and one or more operations users, the one or more finance users being able to allocate the funds; and
creating a plurality of sub-organization accounts, each of the plurality of sub-organization accounts corresponding to a ministry or government agency in the government, each of the plurality of sub-organization accounts storing funds divided by functions performed by sub-organization users, the sub-organization users comprising one or more finance users, one or more human resource users; one or more administrative users, and one or more operations users, any funds paid to the plurality of sub-organization accounts being deposited in the main government account, funds from the main government account being deposited in each of the plurality of sub-organization accounts for use by the corresponding ministry or government agency.

41. A computer-implemented method comprising:
receiving, at a computing system, a listing of at least one law or regulation entered by a government organization, the listing being applicable to an industry or sector; and
displaying, by the computing system, the listing to companies;
receiving, at the computing system, a confirmation from management of the companies of compliance with the listing; and
storing, by the computing system, compliance certificates associated with the companies.

42. The computer-implemented method of claim 41, wherein receiving the confirmation from the management of the companies comprises for each company:
receiving, by the computing system, a confirmation from relevant users to which a head of legal department has allocated the listing; and
receiving, by the computing system, a final confirmation from a board of directors of the company, thereby implementing a two level compliance certificate.

43. The computer-implemented method of claim 41, wherein the government organization is a department or ministry of health, and the listing includes medical checks required for employment and visas.

44. The computer-implemented method of claim 41, wherein the government organization is an immigration department or ministry, and the listing includes types of visas, and the method further comprises:
linking, by the computing system, the listing to a visa section.

45. The computer-implemented method of claim 41, wherein the government organization is a department or ministry of labor, and the listing includes minimum working hours, maximum working hours, and a standard contract for certain types of employees.

46. The computer-implemented method of claim 41, further comprising:
displaying, by the computing system, licenses required by companies;
after a company obtains a license, displaying, by the computing system, at least one of a registration date, an expiration date, and a cost of renewal, entered by the government organization; and
sending, by the computing system, a remainder when the expiration date approaches.

47. A computer-implemented method comprising:
establishing, by a computing system, a plurality of accounts for a plurality of users;
receiving, by the computing system, an identification of at least one purchase that a particular one of the users would like to block; and
preventing, by the computing system, the particular user from making the at least one purchase.

48. The computer-implemented method of claim 47, wherein the particular user belongs to a certain religion, and the at least one purchase comprises pork, beef or alcoholic items.

49. The computer-implemented method of claim 47, wherein the particular user is allergic to nuts, and the at least one purchase comprises products with nuts.

50. A computer-implemented method comprising:
displaying, by a computing system, a tab to a finance user;
receiving, by the computing system, a request to add an individual to a board of directors, the request being entered by the finance user using the tab;
receiving, by the computing system, confirmations of the request from an operations user, an administrative user, and an human resources user;
adding, by the computing system, the individual to the board of directors after receiving the confirmations;
receiving, by the computing system, minutes after a board meeting, the minutes having been entered into the computing system by a sender;
sharing, by the computing system, the minutes with members of the board of directors;
receiving, by the computing system, comments with respect to the minutes from the members;
receiving, by the computing system, edits to the comments entered by the sender;
receiving, by the computing system, confirmation of the minutes as final from the members; and
tracking, by the computing system, a track register that lists users with which the minutes have been shared, the minutes only being shareable by a chairperson of the board.

51. A computer-implemented method comprising:
receiving, by a computing system, a will entered by a user, at least one asset listed in the will as being owned by the user being on the computing system;
receiving, by the computing system, a confirmation of the will from a lawyer;
filing, by the computing system, the will with a government organization;
receiving, by the computing system, a notification that a change related to the will has occurred, the notification having been entered by a heir or a beneficiary; and
sending, by the computing system, a notification to the user and the lawyer that the will needs to be updated.

52. The computer-implemented method of claim 51, wherein the change comprises a change in ownership of a particular asset listed in the will or something else has happened.

53. The computer-implemented method of claim 51, wherein the beneficiary is set to inherit a certain asset if the beneficiary is below a certain age, and the method further comprises:
sending, by the computing system, a notification to the beneficiary when the beneficiary reaches the certain age.
